(19) United States
(12) Patent Application Publication
(10) Pub. No.: US 2024/0397850 A1
(43) Pub. Date: Dec. 5, 2024

(54) METHOD AND SYSTEM FOR CONTINUOUS FLOW SEED TREATER DATA ACQUISITION, COMMERCIALIZATION, AND USE

(71) Applicant: AGINNOVATION LLC, Walnut Grove, CA (US)

(72) Inventor: Peter Marks, Lodi, CA (US)

(73) Assignee: AGINNOVATION LLC, Walnut Grove, CA (US)

(21) Appl. No.: 18/699,730

(22) PCT Filed: Nov. 2, 2022
(86) PCT No.: PCT/US2022/079135

§ 371 Date: Apr. 9, 2024

Related U.S. Application Data
(60) Provisional application No. 63/274,604, filed on Nov. 2, 2021.

(51) Int. Cl. A01C 1/06

(52) U.S. Cl. CPC A01C 1/06

(57) ABSTRACT

A method and system for continuous flow seed treater data acquisition, commercialization, and use. The method and system include, for example, a seed treater with one or more seed treatment inputs, one or more seed treater operations, and one or more environmental inputs for treating seed at a controlled rate. Seed is treated with at least one of the one or more seed treatment inputs, and at least one of the one or more seed treater operations are controlled based on the at least one of the one or more seed treatment inputs.

### CROSS-REFERENCE TO RELATED APPLICATIONS

This application claims priority under 35 U.S.C. § 119 to provisional application Ser. No. 63/274,604 filed Nov. 2, 2021, which is incorporated by reference in its entirety.

### FIELD OF THE DISCLOSURE

The present disclosure relates to a continuous flow seed treater. More particularly, but not exclusively, the present disclosure relates to a method and system for continuous flow seed treater data acquisition, commercialization, and use.

### BACKGROUND

Commercial, large volume, seed treaters, whether vertical or otherwise, are known; however, such seed treaters do not provide an efficient, economical, and predictable research, testing, and studies platform to assess the viability and scalability of improving seed treatment processes and seed treatment slurries in view of the all the accompanying factors and considerations that impact the study and further development of improved seed treatment processes and seed treatment slurries using known systems and technologies. Moreover, scaling these methods, processes, and systems for large-scale commercial use is difficult, unsustainable, and ghastly unpredictable.

Therefore, what is needed is a continuous flow seed treater that addresses the deficiencies in seed treatment processes and slurries along with the industry inhibitors for the continued development and study of seed treatment processes and slurries using a method and system for continuous flow seed treater data acquisition, commercialization, and use that includes the necessary data acquisition, processing protocols, and predictive software that can adjust treater operations in real-time based on any number of factors, including, but not limited to, the type and makeup of seed treatment slurry, the type and makeup of powder, treatment residual effects, treatment environment, treater operations, sensor data, type and makeup of seed, treated seed analytics, calibration protocols, software system, and machine learning & artificial intelligence.

### SUMMARY

Therefore, it is a primary object, feature, or advantage of the present disclosure to improve over the state of the art.

It is a further object, feature, or advantage of the present disclosure to provide a database with seed treatment protocols for at least one or more conditions for a seed, a seed treatment, an environment and for varying scales of laboratory to commercial seed treatment operations.

It is a still further object, feature, or advantage of the present disclosure to provide seed treatment protocols, processes, and constraints for material and operational inputs into a seed treatment processes that provides variable throughput ranging from laboratory testing to commercial seed treatment production.

Another object, feature, or advantage is to provide a seed treater with one or more seed treatment operations that are executed, controlled, recorded, and calibrated using seed treater software.

Yet another object, feature, or advantage is to provide a seed treater having operations, analytics, and data operable using asynchronous machine learning and artificial intelligence.

In at least one exemplary aspect, a method for seed treater data acquisition, commercialization, and use is disclosed. The method includes such steps, as, for example, providing a seed treater with one or more seed treatment inputs having one or more known properties, one or more seed treater operations, and one or more environmental inputs having one or more measurable properties resulting from an environment of the seed treater for treating seed, treating seed in the seed treater with at least one of the one or more seed treatment inputs, and controlling at least one of the one or more seed treater operations based on one or more programmed seed treatment parameters, the one or more known properties of the at least one of the one or more seed treatment inputs and the one or more measurable properties of the at least one of the one or more environmental inputs. The method may also include, for example, such step as adjusting the at least one of the one or more seed treater operations based on inspection of one or more properties of a treated seed. The method may also include, for example, such step as storing the one or more known properties for the seed treatment inputs and the one or more measurable properties for the environmental inputs in a seed treater database, accessing the seed treater database, and controlling the at least one of the one or more seed treater operations based on the one or more known properties of the at least one of the one or more seed treatment inputs and the one or more measurable properties of the at least one of the one or more environmental inputs. The method may also include, for example, such step as acquiring the one or more measurable properties of the at least one of the one or more environmental inputs with one or more sensors within the environment of the seed treater. The method may also include, for example, such step as adjusting a rate of operation of the at least one of the one or more seed treater operations based on the one or more known properties of the at least one of the one or more seed treatment inputs and the one or more measurable properties of the at least one of the one or more environmental inputs. The method may also include, for example, such step as converging actual seed treatment results of the seed treater with the programmed seed treatment parameters using machine learning or artificial intelligence. The method may also include, for example, such step as adjusting a rate of operation of the at least one of the one or more seed treater operations based on one or more sensor readings taken during operation of the seed treater.

In at least one other exemplary aspect, a system for seed treater data acquisition, commercialization, and use is disclosed. The system includes, for example, a seed treater with one or more seed treatment inputs having one or more known properties, one or more seed treater operations, and one or more environmental inputs having one or more measurable properties resulting from an environment of the seed treater, a seed treater database for storing the one or more known properties of the seed treatment inputs, one or more measurements for acquiring the one or more measurable properties resulting from the one or more environmental inputs from the environment of the seed treater, and a controller operating the at least one of the one or more seed treater operations based at least in part on programmed seed treatment parameters, accessing the one or more known properties of the seed treatment inputs from the seed treatment database and the one or more measurements taken from one or more measurable properties resulting from the one or more environmental inputs from the environment of the seed treater.

The system may also include, for example, one or more measurements from one or more sensors for acquiring one or more properties of a treated seed for adjusting one or more seed treater operations. The system may also include, for example, a rate of operation of the at least one of the one or more seed treater operations adjusted by the controller based on the one or more known properties of the at least one of the one or more seed treatment inputs and the one or more measurements taken from one or more measurable properties resulting from the one or more environmental inputs from the environment of the seed treater. The system may also include, for example, a rate of operation of the at least one of the one or more seed treater operations adjusted by the controller based on one or more sensor readings taken during operation of the seed treater. The system may also include, for example, a rate of operation of the at least one of the one or more seed treater operations adjusted by the controller based on feedback from a machine learning and artificial intelligence system. The system may also include, for example, a machine learning and artificial intelligence system operable by the controller for converging actual seed treatment results of the seed treater with the programmed seed treatment parameters using machine learning or artificial intelligence.

In at least another aspect, a method for scaling seed treater data acquisition, commercialization, and use is disclosed. The method includes such steps, as, for example, providing a seed treater with one or more seed treatment inputs having one or more known properties, one or more seed treater operations, one or more environmental inputs from an environment of the seed treater, and a controller for treating seed at a controlled rate, measuring at least one of the one or more environmental inputs from the environment of the seed treater, controlling at least one of the one or more seed treater operations based at least in part on the one or more known properties for the one or more seed treatment inputs and measurements from the at least one of the one or more environmental inputs from the environment of the seed treater. The method may also include, for example, such step as acquiring one or more measurements from at least one or more properties of a treated seed for controlling the at least one of the one or more seed treater operations. The method may also include, for example, such step as acquiring one or more measurements of undischarged portions of at least one of the one or more seed treatment inputs for controlling the at least one of the one or more seed treater operations. The method may also include, for example, such step as controlling at least one of the one or more seed treater operations based on at least one of the one or more seed treatment inputs, the at least one of the one or more environmental inputs, and the controlled rate. The method may also include, for example, such step as controlling at least one of the one or more seed treater operations based at least in part on data retrieved from the database for the seed and one or more measurements of the seed. The method may also include, for example, such step as analyzing at least one of the one or more seed treatment inputs, the at least one of the one or more seed treater operations, the at least one of the one or more environmental inputs using a machine learning and artificial intelligence system for converging actual seed treatment results with programmed seed treatment parameters. The method may also include, for example, such step as loading seed treater software onto the controller, loading seed treatment data for the at least one or more seed treatment inputs, and operating the seed treater at the controlled rate using executables from the seed treatments software and the seed treatment data for the at least one or more seed treatment inputs.

One or more of these and/or other objects, features, or advantages of the present disclosure will become apparent from the specification and claims that follow. No single aspect need provide each and every object, feature, or advantage. Different aspects may have different objects, features, or advantages. Therefore, the present disclosure is not to be limited to or by any objects, features, or advantages stated herein.

### BRIEF DESCRIPTION OF THE DRAWINGS

Illustrated aspects of the disclosure are described in detail below with reference to the attached drawing figures, which are incorporated by reference herein.

FIG. 1 is a pictorial representation of a system for seed treater data acquisition, commercialization, and use in accordance with an exemplary aspect of the present disclosure.

FIG. 2 is a pictorial representation of a communications node in accordance with an illustrative aspect of the present disclosure.

FIG. 3 is a pictorial representation of a sensor node in accordance with an illustrative aspect of the present disclosure.

FIG. 4 is a pictorial representation of a calibration node in accordance with an illustrative aspect of the present disclosure.

FIG. 5 is a pictorial representation of a data tagging, logging, and storage node in accordance with an illustrative aspect of the present disclosure.

FIG. 6 is a pictorial representation of a liquid slurry node in accordance with an illustrative aspect of the present disclosure.

FIG. 7 is a pictorial representation of a powder node in accordance with an illustrative aspect of the present disclosure.

FIG. 8 is a pictorial representation of a seed node in accordance with an illustrative aspect of the present disclosure.

FIG. 9 is a pictorial representation of a treater operations node in accordance with an illustrative aspect of the present disclosure.

FIG. 10 is a pictorial representation of an environment node in accordance with an illustrative aspect of the present disclosure.

FIG. 11 is a pictorial representation of a treated seed node in accordance with an illustrative aspect of the present disclosure.

FIG. 12 is a pictorial representation of a treatment residual node in accordance with an illustrative aspect of the present disclosure.

FIG. 13 is a flowchart illustrating a method for seed treater data acquisition, commercialization, and use in accordance with an illustrative aspect of the present disclosure.

FIG. 14 is a flowchart illustrating a method for seed treater data acquisition, commercialization, and use in accordance with an illustrative aspect of the present disclosure.

FIG. 15 is a flowchart illustrating a method for scaling seed treater data acquisition, commercialization, and use in accordance with an illustrative aspect of the present disclosure.

FIG. 16 is another flowchart illustrating a seed treatment method in accordance with an illustrative aspect of the present disclosure.

FIG. 17 is another flowchart illustrating a seed treatment method in accordance with an illustrative aspect of the present disclosure.

FIG. 18 is another flowchart illustrating a seed treatment method in accordance with an illustrative aspect of the present disclosure.

FIG. 19 is flowchart illustrating a method for scaling seed treater data acquisition, commercialization, and use in accordance with an illustrative aspect of the present disclosure.

FIG. 20 is another flowchart illustrating a method for scaling seed treater data acquisition, commercialization, and use in accordance with an illustrative aspect of the present disclosure.

FIG. 21 is another flowchart illustrating a method for scaling seed treater data acquisition, commercialization, and use in accordance with an illustrative aspect of the present disclosure.

FIG. 22 is another flowchart illustrating a method for scaling seed treater data acquisition, commercialization, and use in accordance with an illustrative aspect of the present disclosure.

FIG. 23 is another flowchart illustrating a method for scaling seed treater data acquisition, commercialization, and use in accordance with an illustrative aspect of the present disclosure.

FIG. 24 is another flowchart illustrating a seed treatment method in accordance with an illustrative aspect of the present disclosure.

### DETAILED DESCRIPTION

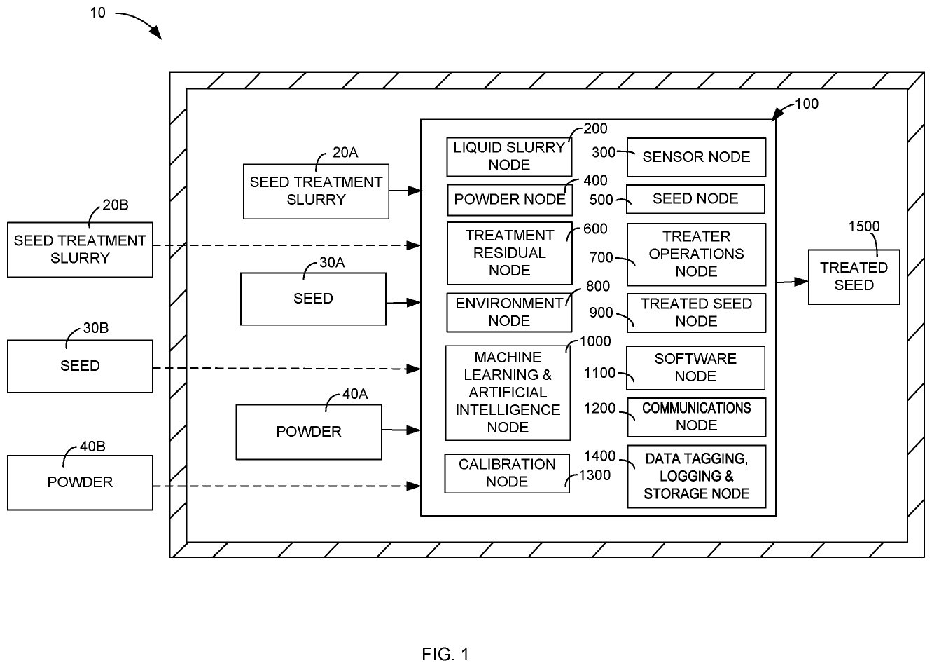

FIGS. 1-24 provide various pictorial illustrations for exemplary aspects of a seed treater system 10 in accordance with the objects, features, and advantages of the present disclosure.

The present disclosure contemplates many different methods and systems for continuous flow seed treatment data acquisition, commercialization and use. Representative applications of methods and systems are described in this section. These examples are provided solely to add context and aid in understanding of the described aspects of the disclosure. It will thus be apparent to one skilled in the art that the described aspects of the disclosure may be practiced without some and/or all of these specific details. In other instances, well known process steps have not been described in detail in order to avoid unnecessarily obscuring the described aspects. Other applications are possible, such that the following examples should not be taken as limiting.

In the following detailed description, references are made to the accompanying drawings, which form a part of the description and show, by way of illustration, specific aspects in accordance with the methods and systems of the present disclosure. Although aspects of the disclosure are described in sufficient detail to enable one skilled in the art to practice the described aspects, it is understood that these examples are not limiting; other aspects may be used, and changes may be made without departing from the spirit and scope of the described aspects of the disclosure.

It will also be understood that, although the terms first, second, next, lastly, etc. may be used herein to describe various elements, these elements should not be limited by such terms. These terms are only used to distinguish one element from another. For example, a first step could be termed a second step, and, similarly, a second step could be termed a first step, without departing from the spirit and scope of the present disclosure.

The terminology used herein is for the purpose of describing particular aspects of the disclosure only and is not intended to be limiting of the present disclosure. As used in the description of the invention and the appended claims, the singular forms “a”, “an” and “the” are intended to include the plural forms as well, unless the context clearly indicates otherwise. By way of example only, while the singular form of numerous components and steps are described in various aspects of the disclosure herein, it will be apparent that more than one of such components and/or steps can be used to accomplish the same. It will also be understood that the term “and/or” as used herein refers to and encompasses any and all possible combinations of one or more of the associated listed items. It will be further understood that the terms “comprises” and/or “comprising,” when used in this specification, specify the presence of stated features, functions, integers, steps, operations, elements, and/or components, but do not preclude the presence and/or addition of one or more other features, integers, steps, operations, elements, components, and/or groups thereof. It will be similarly understood that the terms “including,” “include,” “includes”, “such as” and the like, when used in this specification, are intended to be exemplary and should be construed as including, but not be limited to, all items recited thereafter. As used herein, the term “if” may be construed to mean “when” or “upon” or “in response to determining” or “in response to detecting,” depending on the context.

As used herein, the term “seed” includes seeds of any type of plants, including, but not be limited to, row crops, cereals, grains, oilseeds, fruits, vegetables, turf, forage, ornamental, nuts, tobacco, plantation crops and the like (including, without limitation, cotton and other fiber and hemp and related seeds).

As used herein, the terms “substance” and/or “seed-applied substance” include any composition applied to seeds prior to the seeds being planted (e.g., when the seed comes in contact with the soil in a field). The seed-applied substance(s) can include active ingredients, other substances, combinations of more than one active ingredient and/or other substances, and/or mixtures having one or more active ingredients and/or one or more other substances. The active ingredients can include any type of substance that causes something to occur (for example, the ingredient(s) in a pesticide that impact the pest, the ingredients in a fungicide that impact the disease and/or plant growth, health and/or vigor, the ingredients in a nematicide that impact the nematode, the ingredients in an inoculant and/or other plant growth and/or health substance that cause the plant to improve its growth, health and/or vigor). The active ingredients can include any past, present and/or future active ingredients and can be chemicals, biologicals (including, without limitation, fungal, bacterial, parasitic, insects and other living organisms), biostimulants, micronutrients, and/or other compositions. Examples of some current potential active ingredients include nitrogen, clothianidin, ipconazole, trifloxystrobin, imidacloprid, metalaxyl, pyraclostrobin, bradyrhizobium, myclobutanil, thiamethoxam, abamectin, mefonoxam, fludioxonil, fipronil, azoxystrobin, cyantraniliprole, Rynaxypyr®, and the like. The other substances typically do not impact the target (for example pest, disease, nematode and/or plant growth, health and/or vigor), but can be helpful to include for a variety of reasons, including, but not be limited to, causing the active ingredients to be at the appropriate levels and/or concentrations to be efficacious but not harmful to the seed and/or plant, helping the active ingredient affix and/or stick to the seed, helping the treated seeds not stick to each other and/or other objects, improving the color of the treated seed (e.g., to indicate the seed is treated with a pesticide), increasing the number and/or amount of active ingredients a seed can absorb and/or otherwise carry and the like. Examples of some of these other substances include polymers, pigments, binders, surfactants, colorants, coatings, and other additives. The seed-applied substances can take any form, including, but not be limited to, wet and dry substances.

In at least one exemplary aspect, a system for seed treater data acquisition, commercialization, and use is disclosed, and shown in FIGS. 1-24. The system includes, for example, a seed treater with one or more seed treatment inputs, one or more seed treater operations, and one or more environmental inputs for treating a seed at a controlled rate using a controller, a database for storing data for at least one or more seed treatment inputs, one or more measurements of at least one of the one or more environmental inputs, and at least one of the one or more seed treater operations controlled based at least in part on data retrieved from the database and measurements of the at least one of the one or more environmental inputs. The system may also include, for example, one or more measurements acquired from at least one or more properties of a treated seed for controlling the at least one of the one or more seed treater operations. The system may also include, for example, one or more measurements of undischarged portions of at least one of the one or more seed treatment inputs for controlling the at least one of the one or more seed treater operations. The system may also include, for example, at least one of the one or more seed treater operations based on at least one of the one or more seed treatment inputs, the at least one of the one or more environmental inputs, and the controlled rate. The system may also include, for example, at least one of the one or more seed treater operations controlled based at least in part on data retrieved from the database for the seed and one or more measurements of the seed. The system may also include, for example, a machine learning and artificial intelligence system for analyzing at least one of the one or more seed treatment inputs, the at least one of the one or more seed treater operations, the at least one of the one or more environmental inputs for converging actual seed treatment results with programmed seed treatment parameters.

FIG. 1 illustrates one aspect of the continuous flow seed treater system 10. The seed treater system 10 addresses deficiencies in seed treatment processes and slurries along with the industry inhibitors for the continued development and study of seed treatment processes and slurries using a method and system for continuous flow seed treater data acquisition, commercialization, and use that includes the necessary data acquisition, processing protocols, and predictive software that can adjust treater operations in real-time based on any number of factors, including, but not limited to, the type and makeup of seed treatment slurry, the type and makeup of powder, treatment residual effects, treatment environment, treater operations, sensor data, type and makeup of seed, treated seed analytics, calibration protocols, software system, and machine learning & artificial intelligence.

One or more seed treatment inputs are fed into the continuous flow seed treater system 10. These inputs can include seed treatment slurry 20B, the seeds 30B and the powder 40B. The seed treatment slurry 20A, seeds 30A, and powder 40A may be housed within the continuous flow seed treater 10. The seed treatment inputs are operatively connected to a controller 100 for controlling seed treatment operations. The controller 100 may contain a liquid slurry node 200, a sensor node 300, a powder node 400, a seed node 500, a treatment residual node 600, a treater operations node 700, an environment node 800, a treated seed node 900, a machine learning & artificial intelligence node 1000, a software node 1100, a communications node 1200, a calibration node 1300, or a data tagging, logging, and storage node 1400. During the operation of the seed treater system 10, the seed treatment slurry 20A, 20B and the powder 40A, 40B are combined with the seed 30A, 30B to create a treated seed 1500. The different nodes 200, 300, 400, 500, 600, 700, 800, 900, 1000, 1100, 1200, 1300, and 1400 track data associated with differences measured when compared to the calculated seed treatment outcomes based on the seed treatment operating parameters, leftover residue, and environmental conditions. Applying machine learning and artificial intelligence models to the data can adjust seed treatment paraments for varying circumstances and conditions to increase the accuracy of consistently achieving the desired seed treatment outcomes for a calculated seed treatment. For example, optimal seed treatment parameters are determined based on data received during initial testing in a laboratory and then stored in a database. A manufacturer, having current data matching the data collected and stored in the database, can set the operational parameters of hundreds of seed treater systems 10 in the plant to those same operational parameters thereby producing optimal treated seed while reducing any residue left in the seed treatment system.

The seed treatment system 10 enables improved accuracy in treated seed preparation by providing an as-fed treated seed ingredients that best approximates the formulated seed treatment to ensure the adhesion of the seed treatment to the seed and reduction of remaining residue. It is to be noted that the one or more applications, mobile or otherwise, for enabling and working with the seed treater system 10 may be accessed using a computer-based platform, such as for example on a desktop, laptop, or tablet computing device, or a mobile device. The seed treatment system 10 provides for, amongst other things, the asynchronous monitoring, receiving, storing, tracking, discharging, measuring, and aggregating treated seed.

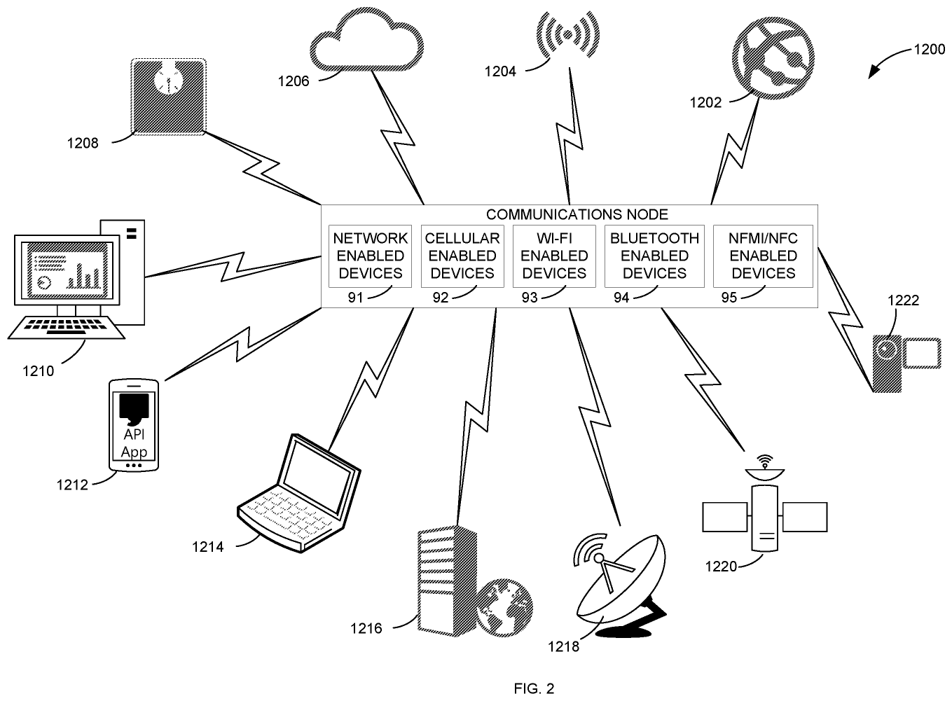

The communications node 1200, as shown in FIG. 1 and FIG. 2, may be operatively connected to one or more of the other nodes and housed within a controller 100 of the seed treater system 10. The communication node 1200 allows the seed treater system 10 to communicate with a plurality of devices. Thereby allowing any data acquired by the seed treater system 10 to be communicated remotely, such as from a manufacturing floor to a manufacturing office. The communications node 1200 may be enabled to communicate with remote devices. A feed ration may be entered, updated, downloaded, adjusted, viewed, printed, cast, or visualized using the communications node 1200. The communications node 1200 may include, for example, but is not limited to, network enabled devices 91, cellular enabled devices 92, Wi-Fi enabled devices 93, Bluetooth enabled devices 94 and/or NFMI/NFC enabled devices 95. These devices and systems can include, but are not limited to, earth-orbiting satellites 1220, video/image capture 1222, web apps 1202, RFID systems 1204, cloud systems 1206, scale/load cell devices 1208, computer systems 1210, smartphones 1212, laptop devices 1214, web server systems 1216, and ground-based satellite 1218. Manual or automated updates and changes to seed treater operations may occur as a result of seed treater system data manually entered, seed treater system data retrieved from one or more databases or nodes, data configured, reconfigured, reapportioned, or any substitutions made as a result of one or more known or measured properties of available and/or unavailable seed treater operations for one or more batch requests, and further based on measured, learned or artificially derived treated seed, residual data and/or batch information, using one or more of the nodes 200, 300, 400, 500, 600, 700, 800, 900, 1000, 1100, 1200, 1300, 1400. The slurry, powder and seed contents for a seed treatment can be received, stored, tracked, ordered, discharged, measured, aggregated, and used to prepare a treated seed by tracking and logging feed content(s) by creating feed content(s) logs, including tagging, logging, and storing data, using, for example, data tagging, logging, and storage node 1400. The data and activities from the seed treatment logs can be used asynchronously or otherwise for iterating accuracy of the seed treater system 10 processes through the machine learning and artificial intelligence node 1000. For example, environmental conditions may call for a specific seed treatment ingredient to be adjusted to provide for an optimally treated seed and has marginal impact on the treated seed. In this instance, the seed treater system 10 may, for example, using machine learning and/or artificial intelligence, provide to a user/operator updated or adjusted seed treatment parameters based on one or more ingredients, taking into consideration one or more factors and data from operation of the one or more nodes 200, 300, 400, 500, 600, 700, 800, 900, 1000, 1100, 1200, 1300, or 1400.

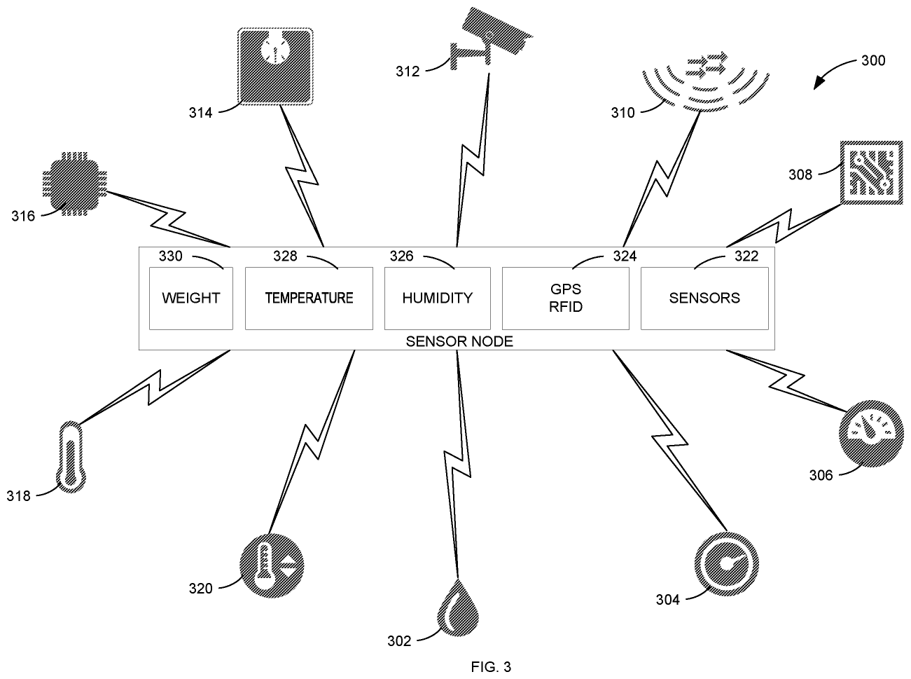

The sensor node 300 may be operatively connected to the communications node 1200 or any other node of the seed treater system 10 and housed within the controller 100, as shown in FIGS. 1 and 3. Sensors, such as for detecting weight 330, temperature 328, humidity 326, location via GPS/RFID 324, and other sensors 322 may be configured to provide sensed, measured, or detected data to the seed treater system 10. In at least one configuration, the sensor node 300 can include detectors or sensors for detecting and/or sensing pH, moisture, humidity 302, performance 304, barometric 306, electronic 308, flow 310, image 312, scale/load cell 314, processor 316, temperature 318, HVAC 320, weight 330, temperature 328, humidity 326, location via GPS/RFID 324, and other sensors 322 for detecting, tracking, and logging data relating to the difference between one or more seed treatment parameters and their corresponding as-treated seed and remaining residue by creating detection logs, including tagging, logging, and storing data, using, for example, data tagging, logging, and storage node 1400 in combination with machine learning and artificial intelligence node 1000. The sensing devices allow the seed treater system 10 to monitor the seed, seed treatment, and seed environment. The environmental measurements can be measured daily, hourly, or at specific times. The environmental sensors may be in different locations to determine how the environmental factors affect the seed treatment operations. For example, if the seed is placed outside in the morning prior to being loaded into the seed treater system 10, the humidity and temperature may be measured in the morning at a time right before the seed is placed into the seed treater system 10 to measure if any temperature change occurred and how the temperature change may affect the parameters of the seed treatment operations. The sensors may be used to determined how environmental factors affect the slurry, the seed, or powder independently or collectively and whether different parameters are needed to treat the seed prior to running the seed treater system 10.

The seed treater system 10 may have additional sensors 322, that stores data or a database from the other sensors or machine data. The machine data sensed may include the speed a tumbler of the seed treater system 10 is moving, the flow of the slurry into the seed treater system 10, the amount of slurry, the consistency of the powder, the amount of powder, the rate the powder enters the seed treater system 10, the rate the seeds enter the seed treater, the number of seeds, and/or how much slurry, powder, or seeds remain in the seed treater system after the treated seed 1500 exists the seed treater system 10. These factors may affect the next cycle of parameters for the seed treatment operations. For example, if there is slurry left in the seed treater system 10, the amount of slurry inputted into the seed treatment system may be reduced, thus saving time as cleaning the seed treater system 10 may not be needed if the slurry is not left in the seed treater system 10. If a manufacturer has hundreds of seed treater systems 10, it is beneficial to adjust the seed treater parameters based off the sensor node 300 readings. If leftover slurry is clogging hundreds of seed treater systems 10, the cost and manpower for shutting down the machinery and cleaning the machinery may be enormous.

The sensor node 300 may have an alert system that alerts the manufacturer, farmer, or producer to any changes that may affect seed treater system 10 operations. For example, the alert may indicate that the temperature has increased during the time the seed was stored outside meaning the seed has expanded, therefore the amount of slurry needed to coat the seed may need to be increased or decreased to optimally treat the seed.

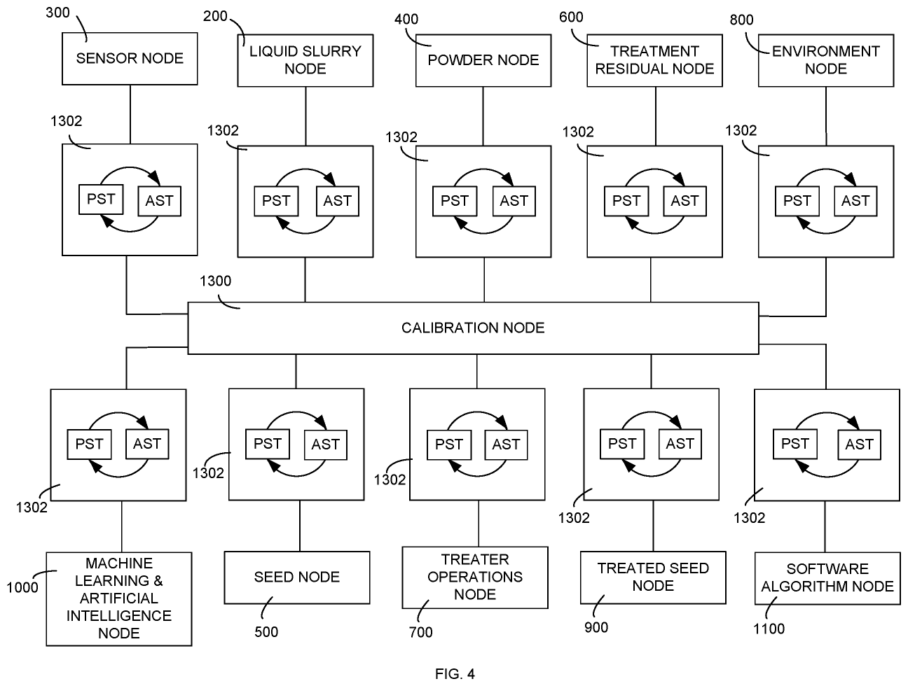

Each node may need to be calibrated by the calibration node 1300 to ensure the seed treater system 10 is running optimally. The calibration node may run a series of calibration tests 1302 on each of the nodes, as shown in FIG. 4. The calibration node 1300 may be operatively connected to one or more of the other nodes and housed in the controller 100. The calibration node 1300 may calibrate the sensor node 300 to ensure the sensors are working properly or are communicating data properly through a series of calibration tests 1302. These tests can be run daily, hourly or on a specific time schedule to test the percentage of possible failure modes to reduce the probability of failure in the future, extend the time between compulsory shutdowns, predict when a system may fail or need to be shut down, and prioritize maintenance tasks. The calibration tests may also reset a sensor or the sensor node 300. The calibration node 1300 may also run calibration tests 1302 on the liquid slurry node 200, the powder node 400, the treatment residual node 600, the environment node 800, the machine learning & artificial intelligence node 1000, the seed node 500, the treater operations node 700, the treated seed node 900 and the software algorithm node 1100. The calibrating tests 1302 may include reefing the initial selection of parameters by comparing model results with a set of observed data, estimating values from available properties based on established empirical relationships, or using measured values. Data collected from the calibration node may be stored in one or more databases.

The calibration node 1300 is configured to compare the calculated remaining residue and the calculated treated seed parameters with the as-treated seed and actual remaining residue. In another aspect, the calibration node compares the calculated seed disbursement with the actual seed disbursement based on operations of the seed node 500. In still another aspect, the calibration node compares the calculated liquid slurry disbursement with the actual liquid slurry disbursement from the liquid slurry node 200. In yet another aspect, the calibration node 1300 compares the calculated powder disbursement with the actual powder disbursement from the powder node 400. In still another aspect, the calibration node 1300 compares the calculated treater operations with the actual treater operations from the treater operations node 700. In still other aspects, the calibration node 1300 compares the calculated treated seed parameters with the actual treated seed disbursement from the treated seed node 900. The calibration node 1300 can calibrate operations of the nodes and/or modules by making operational adjustments to minimize any differences between the calculated seed treatment data and the measured seed treatment data (i.e., data acquired from one or more operations of one or more nodes/modules for providing and from measuring an as-treated seed and the remaining residue).

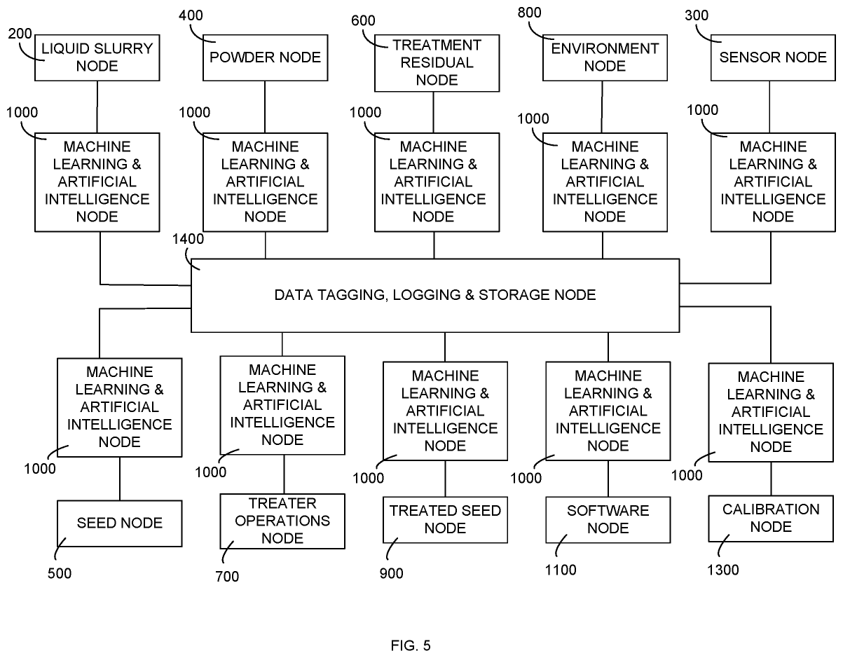

The data tagging, logging and storage node 1400 communicates with the other nodes and may be housed in the controller 100, as shown in FIG. 5. The data tagging, logging and storage node 1400 may receive data from the plurality of other nodes within the seed treater system 10 and tag the data. The tagging allows for data to be easily organized and labeled. The tagging may consist of where the data was acquired, what node the data was communicated through, where the data should be stored, or where the data should be communicated to. The data can be logged and stored in a database. Data can be received from the liquid slurry node 200, the powder node 400, the treatment residual node 600, the environmental node 800, the sensor node 300, the seed node 500, the treater operations node 700, the treated seed node 900, the software node 1100, or the calibration node 1300. Prior to reaching the data tagging, logging, and storage node 1400 the data may be communicated to the machine learning and artificial intelligence node 1000 and then the data may proceed to the data tagging, logging and storage node 1400. The data tagging, logging, and storage node 1400 may contain one or more databases for storing data from each of the nodes.

The present disclosure contemplates that many different types of machine learning and artificial intelligence may be employed by the machine learning and artificial intelligence node 1000, and therefore, the one or more machine learning and artificial intelligence layers may include, but are not limited to, k-nearest neighbor (kNN), logistic regression, support vector machines or networks (SVM), linear regression, logistic regression, decision tree, naïve Bayes, K-Means, Random Forest, dimensionality reduction algorithms, gradient boosting algorithms (e.g., GBM, XGBoost, LightGBM, CatBoost), and/or more neural networks. Regardless, the use of machine learning and artificial intelligence in the framework and workflow of the present disclosure enhances the utility of analyzing known and/or collected data and its various components by automatically and heuristically constructing appropriate relationships, mathematical or otherwise, relative to the seed, slurry, and environment variables influencing follow-on outcomes such as continuously treating seed and adjustment of amounts and types of inputs into the seed treating systems and processes. The machine learning and artificial intelligence node 1000 may be housed in the controller 100 and may be associated with one or more databases. For example, the machine learning and artificially intelligence node 1000 may analyze at least one of the one or more seed treatment inputs, the at least one of the one or more seed treater operations, the one or more environmental inputs for treating seed at the controlled rate and converge actual seed treatment results with programmed seed treatment parameters.

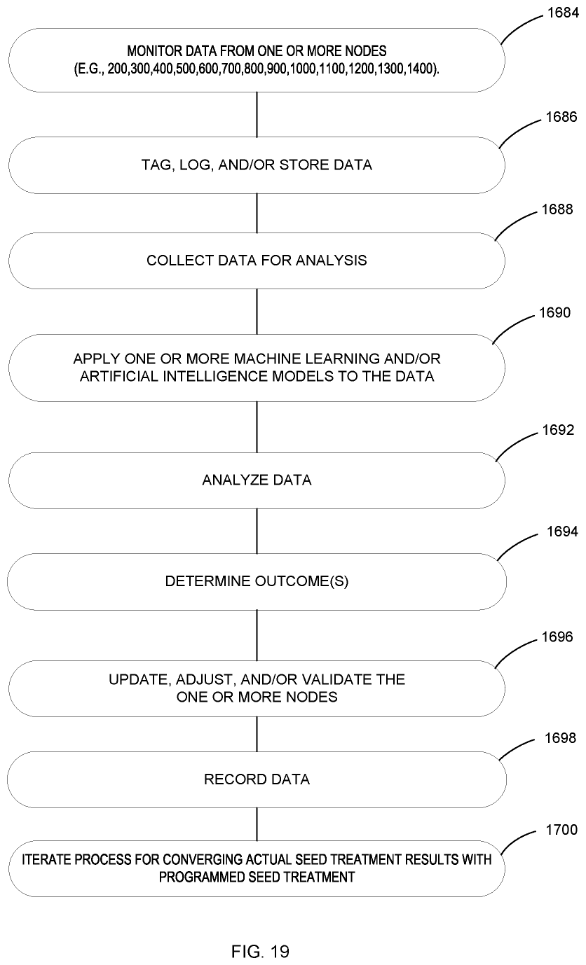

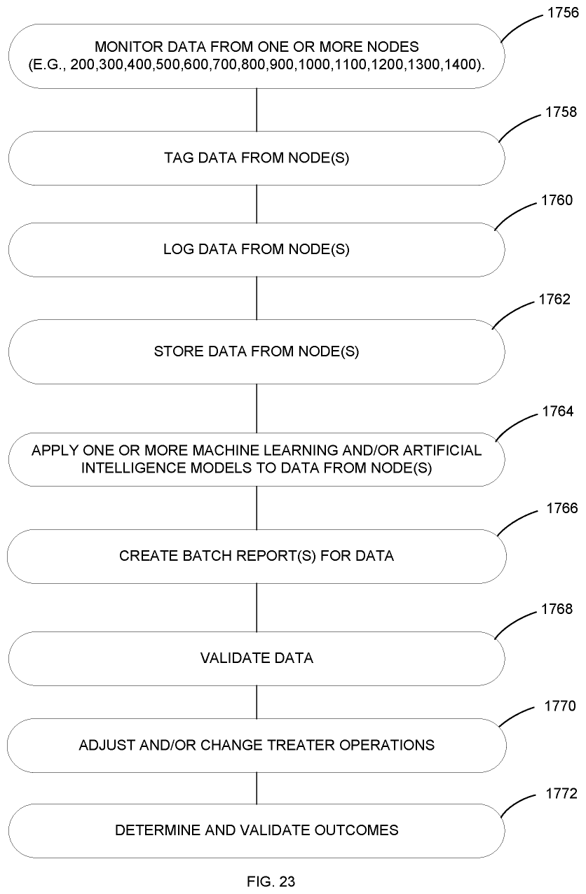

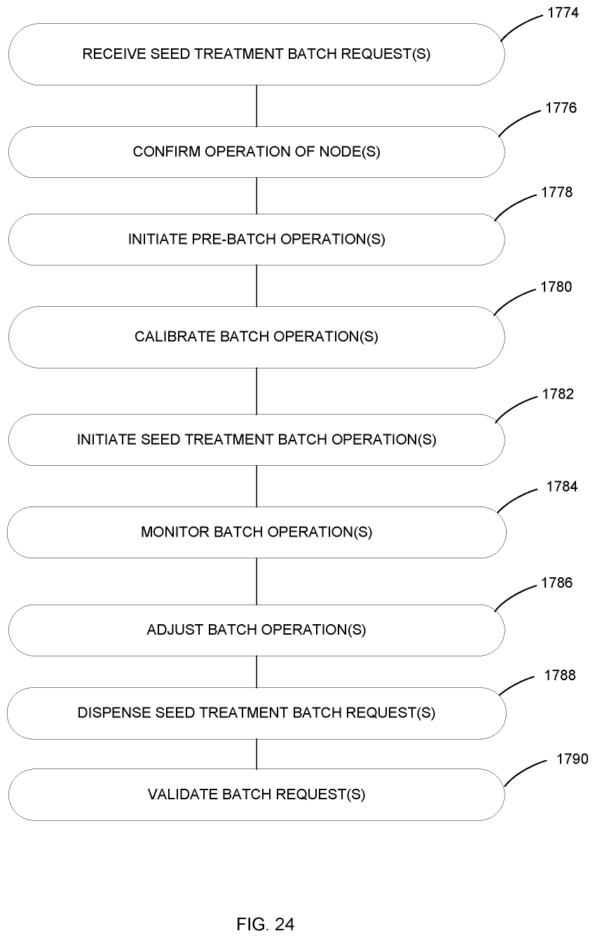

The machine learning and artificial intelligence node 1000 may be configured to apply one or more machine learning and artificial intelligence models to the data. For example, in at least one aspect, a machine learning and artificial intelligence node 1000 monitors data, such as operation data, for each node to, for example, monitor the health, operational accuracy, and to adjust, report problems, and fine tune operations of each node, such as, for example, provided in FIGS. 19 and 23. In one aspect, the machine learning and artificial intelligence node 1000 monitors operations of the treater operations node 700 and, using present, historical, and predictive data tagged, logged, and stored at node 1400, monitors the health, operational accuracy, and adjusts operations, reports problems, and fine tunes batch processing and accuracy, such as, for example, those provided by the flowchart in FIG. 24. In another aspect, the machine learning and artificial intelligence node 1000 monitors operations of the environmental node 800 and, using present, historical, and predictive data tagged, logged, and stored at node 1400, monitors the health, operational accuracy, and adjusts operations, reports problems, and fine tunes batch processing and accuracy. In still another aspect, the machine learning and artificial intelligence node 1000 monitors operations of the treatment residual node 600 and, using present, historical, and predictive data tagged, logged, and stored at node 1400, monitors the health, operational accuracy, and adjusts operations, reports problems, and fine tunes batch processing and accuracy. In yet another example, the machine learning and artificial intelligence node 1000 monitors operations of the treated seed node 900 and, using present, historical, and predictive data tagged, logged, and stored at node 1400, monitors the health, operational accuracy, and adjusts operations, reports problems, and fine tunes batch processing and accuracy. In still other aspects, the machine learning and artificial intelligence node 1000 monitors operations of the seed node 500 and, using present, historical, and predictive data tagged, logged, and stored at node 1400, monitors the health, operational accuracy, and adjusts operations, reports problems, and fine tunes batch processing and accuracy. In another aspect, the machine learning and artificial intelligence node 1000 monitors operations of the powder node 400 and, using present, historical, and predictive data tagged, logged, and stored at node 1400, monitors the health, operational accuracy, and adjusts operations, reports problems, and fine tunes batch processing and accuracy. In yet another aspect, the machine learning and artificial intelligence node 1000 monitors operations of the liquid slurry node 200 and, using present, historical, and predictive data tagged, logged, and stored at node 1400, monitors the health, operational accuracy, and adjusts operations, report problems, and fine tunes batch processing and accuracy. In yet another aspect, the machine learning and artificial intelligence node 1000 monitors operations of the sensor node 300 and, using present, historical, and predictive data tagged, logged, and stored at node 1400, monitors the health, operational accuracy, and adjusts operations, report problems, and fine tunes batch processing and accuracy. Measurements taken for identifying, tagging, logging, and storing data based on operation of the nodes and modules can be, in at least one aspect, performed and provided, at least in part, by one or more devices of the sensor node 300. The machine learning and artificial intelligence node 1000 can calibrate operations of the nodes and/or modules using data from the nodes and modules by making, for example, operational adjustments to minimize any differences between the calculated seed treatment data and the measured seed treatment data (i.e., data acquired from one or more operations of one or more nodes/modules for providing and from measuring an as-treated seed).

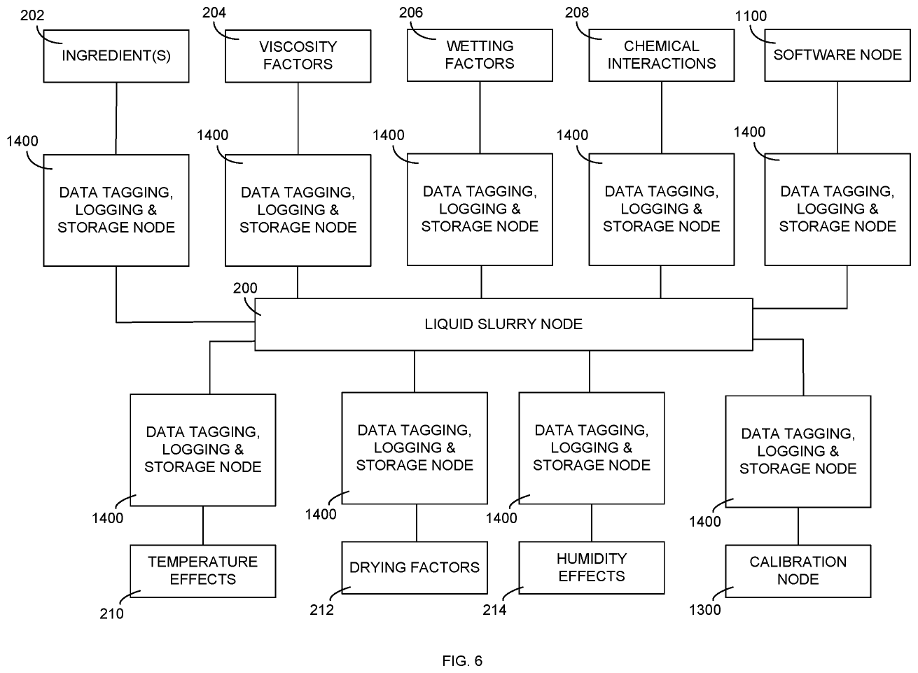

The liquid slurry node 200 can communicate or is operatively connected to the other nodes within the seed treater system 10 and may receive or communicate data regarding liquid slurry properties, as shown in FIG. 6. The liquid slurry node 200 may be housed in the controller 100. The liquid slurry node 200 can communicate data collected from various liquid slurry inputs to the data tagging, logging and storage node 1400 or receive the required operating parameters from the data tagging, logging and storage node 1400. These inputs can include the ingredients 202 that the slurry is made of or should consist of, or the chemical interactions 208 between the liquid slurry and the powder, the liquid slurry and the seed, and the interaction between the liquid slurry, the powder and the slurry. The inputs can include viscosity factors 204 such as temperature, pressure, structure, the effect of the composition of the slurry, the effect of the composition of the powder on the viscosity of the slurry, or any other viscosity factor 204. The data may also include wetting factors 206, such as whether a wetting agent is needed or is being used, the ability of the liquid slurry to maintain contact with the surface of the seed, the ability of the liquid slurry to maintain contact with the powder, or any other wetting factors 206. The inputs may also include temperature effects 210, such as how the outside temperature or environmental temperature effects the liquid slurry or the liquid slurry's interactions with the powder and seed, how the temperature can affect the wetting factors 206, the viscosity factors 204, or the drying factors 212. Drying factors 212 may include how the slurry dries on the seed, what factors can cause the liquid slurry to start to dry, or how the chemical interactions 208 affect the drying of the liquid slurry. The inputs can include humidity effects 214, such as how the humidity affects the ingredients 202 of the liquid slurry, the interactions of the liquid slurry with the powder and the seed, the drying factors 212, the wetting factors 206, the viscosity factors 204 or how the humidity affects any other properties of the liquid slurry. The liquid slurry node 200 may also communicate data to and receive data from the calibration node to ensure that the liquid slurry node is functioning properly or optimally. The calibration node 1300 may also communicate adjustments that need to be made to the liquid slurry. The liquid slurry node 200 may also communicate or receive data from the software node 1100. The software node 1100 may receive the data from the liquid slurry node 200 to determine if the parameters of the seed treater system 10 need to be adjusted or the software node 1100 may communicate adjustments to liquid slurry parameters. The liquid slurry node 200 may be associated with one or more databases

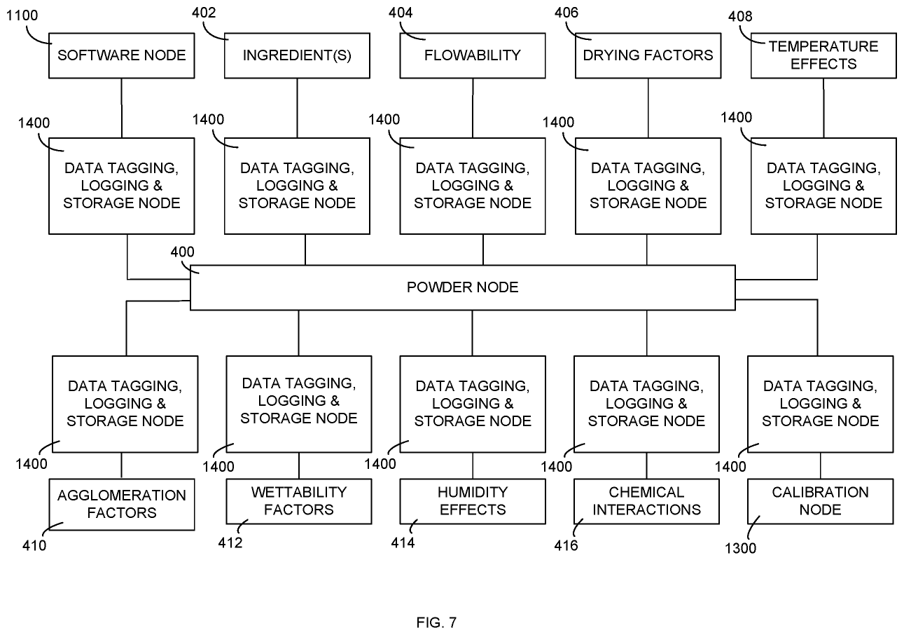

The powder node 400 may communicate with other nodes regarding data or operating parameters for the powder, as shown in FIG. 7. The powder node 400 may be housed in the controller. The powder node 400 can communicate data collected from various inputs to the data tagging, logging and storage node 1400 or receive the required operating parameters from the data tagging, logging and storage node 1400. The powder node 400 may also communicate data to and receive data from the calibration node 1300 to ensure that the powder node 400 is functioning properly or optimally. The calibration node 1300 may also communicate adjustments that need to be made to the powder in light of data received from the other nodes, the data tagging, logging and storage node 1400, or from the powder node 400 itself. The powder node 400 may also communicate or receive data from the software node 1100. The software node 1100 may receive the data from the powder node 400 to determine if the parameters of the seed treater system 10 need to be adjusted or the software node 1100 may communicate adjustments to powder inputs or parameters. The inputs can include the ingredients 402 of the powder or the flowability of the powder 404. The inputs may include drying factors 406, such as how the powder adheres to the seed, and the temperature effects 408, such as how the environmental temperature or temperature change affects the powder properties or the powder's interactions with the liquid slurry or the seed. The inputs can also include agglomeration factors 410 of the powder, such as lack of flowability, particle size, temperature, or humidity. The inputs may also include wettability factors 412, such as particle size, density, the presence of moisture-absorbing substances, surface properties of the powder, or any other factor that may affect wettability. The inputs may include humidity effects 414 such as whether the powder is likely to take on unwanted surface moisture, how the humidity may affect agglomeration or flowability or the chemical interactions between the powder, slurry and seed. The inputs may also include chemical interactions 416, such as the chemical interactions between the slurry and the powder, the powder and the seed, or the interactions between the slurry, powder and the seed. The powder node may be associated with one or more databases of the seed treatment system 10.

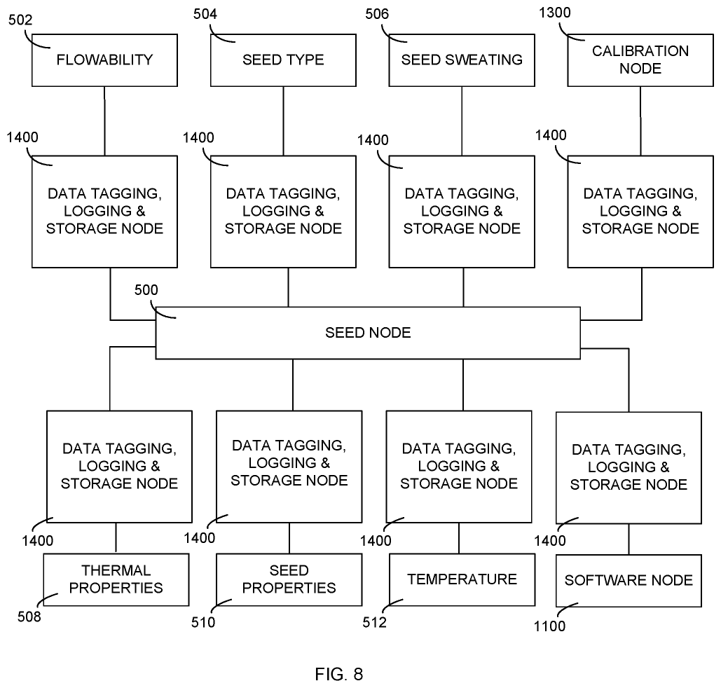

The seed node 500 may communicate with other nodes of the seed treater system and may collect, receive, or communicate different seed data, inputs and parameters to the other nodes as shown in FIG. 8. The seed node may be housed in the controller 100. The seed node 500 can communicate data regarding different data points to the data tagging, logging, and storage node 1400 or receive the required operating parameters from the data tagging, logging, and storage node 1400. The seed node 500 may also communicate data to and receive data from the calibration node 1300 to ensure that the seed node 500 is functioning properly or optimally. The calibration node 1300 may also communicate adjustments that need to be made to the seed inputs in light of data received from the other nodes, the data tagging, logging and storage node 1400 or from the seed node 500 itself. The seed node 500 may also communicate or receive data from the software node 1100. The inputs may include a flowability input 502, which can include how fast the seed is flowing into the seed treater system 10, or the seed type 504. The seed input may include seed sweating 506 input, such as how likely is the seed to sweat, what may cause the seed to sweat, and/or how the seed sweating can affect the seed's interaction with the liquid slurry or powder. The seed input may include thermal properties 508 of the seed, such as how thermal properties of the seed treater system 10 affect the seed, specific heat of the seed, thermal conductivity of the seed and thermal diffusivity of the seed, and how the thermal properties 508 physically and chemically affect the seed. The input may be seed properties 510 which can include physical properties (volume, mass, coat hardness, shape, texture, and coat thickness of seeds) or chemical properties (crude fat, soluble protein, sugar, gibberellins and abscisic acid, adhesiveness). The input may be seed properties 510 relating to size, shape, surface area, and surface topography of seed to adjust the seed treatment. The surface area of different seeds varies resulting in changes to the seed treatment process. In one aspect, a sample for a batch of seed provides a baseline for the average size, shaped, surface area, and surface topography. Initial seed treatment parameters can be established using the baseline and adjusted during operations using the methods and systems herein. For example, changes in seed features may require changes in the seed treatments and process. Treatments rates of the seed treater can be adjusted according to seed type. Another seed input may be temperature 512. The temperature input may include how the ambient or environmental temperature affects the seed, the temperature of the seed or the environment immediately surrounding the seed, or the temperature of the seed before and after being treated. The seed node 500 may be associated with one or more databases of the seed treater system 10.

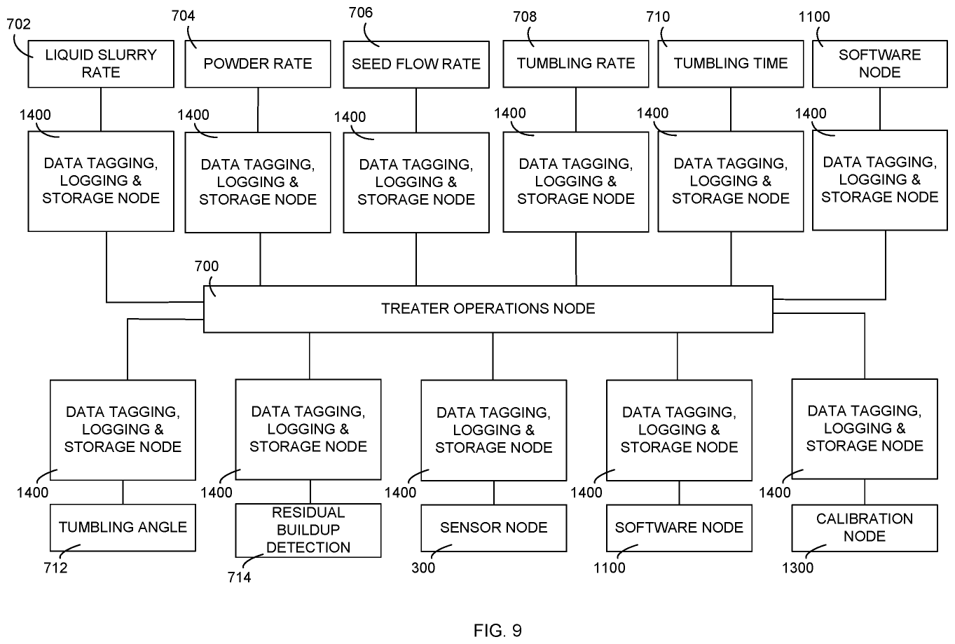

The treater operations node 700 may communicate with other nodes of the seed treater system 10 and may collect, receive, or communicate different treater operations inputs to the other nodes as shown in FIG. 9. The treater operations node may be housed in the controller 100. The treater operations node 700 can communicate data regarding different data points to the data tagging, logging and storage node 1400 or receive the required operating parameters from the data tagging, logging and storage node 1400. The treater operations node 700 may also communicate data to and receive data from the calibration node 1300 to ensure that the treater operations node 700 is functioning properly or optimally. The treater operations node 700 may also communicate adjustments that need to be made to the operation inputs or parameters in light of data received from the other nodes, the data tagging, logging and storage node 1400 or from the treater operations node 700 itself. The treater operations node 700 may also communicate or receive data from the software node 1100 or the sensor node 300 through the data tagging, logging and storage node 1400. The inputs into the treater operations node may include the liquid slurry rate 702 into the tumbler or into the seed treater system 10, the powder rate 704 of flow into the tumbler or into the seed treater system, and the seed flow rate 706 into the tumbler or seed treater system 10. The inputs may involve the operation of the tumbler mixing the slurry, powder, and seed together to form the treated seed 1500 such as the tumbling rate 708, tumbling time 710, and tumbling angle 712. Another treater operations node 700 input may include residual buildup detection 714 to detect any residual slurry, powder, seeds, or treated seeds in the tumbler. The treater operations node 700 may be associated with one or more databases of the seed treater system 10.

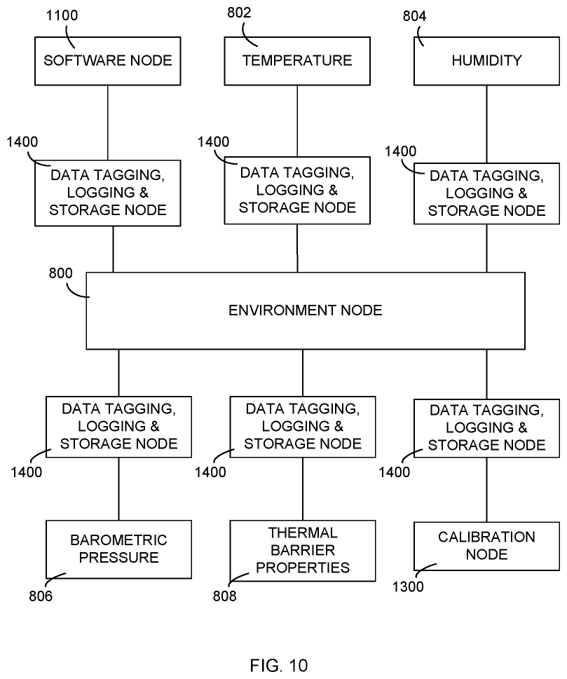

The environmental node 800 may communicate with other nodes of the seed treater system 10 and may collect, receive, or communicate different treater operations inputs to the other nodes as shown in FIG. 10. The environmental node may be housed in the controller 100. The environmental node 800 can communicate data regarding different data points to the data tagging, logging and storage node 1400 or receive the required operating parameters from the data tagging, logging and storage node 1400. The environmental node 800 may also communicate data to and receive data from the calibration node 1300 to ensure that the environmental node 800 is functioning properly or optimally. The environmental node 800 may also communicate adjustments that need to be made to the operation parameters in light of data received from the other nodes, the data tagging, logging and storage node 1400 or from the environmental node 800 itself. The environmental node 800 may also communicate or receive data from the software node 1100 through the data tagging, logging and storage node 1400. The environmental inputs may include temperature 802, humidity 804, barometric pressure 806 and thermal barrier properties 808. The environmental node 800 may be associated with one or more databases of the seed treater system 10.

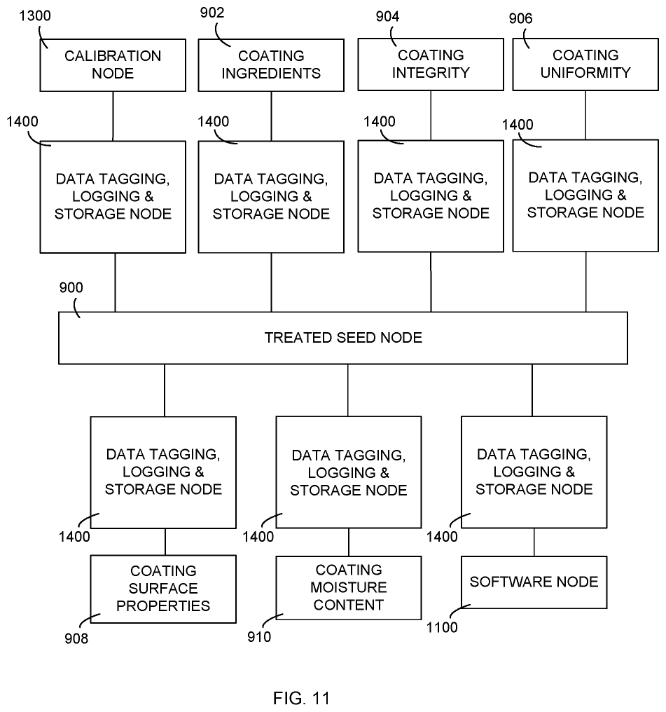

The treated seed node 900 may communicate with other nodes of the seed treater system 10 and may collect, receive, or communicate different treated seed inputs to the other nodes as shown in FIG. 11. The treated seed node 900 may be housed in the controller 100. The treated seed node 900 can communicate data regarding different data points to the data tagging, logging and storage node 1400 or receive the required operating parameters from the data tagging, logging and storage node 1400. The treated seed node 900 may also communicate data to and receive data from the calibration node 1300 to ensure that the environmental node 800 is functioning properly or optimally. The treated seed node 900 may also communicate adjustments that need to be made to the operation parameters in light of data received from the other nodes, the data tagging, logging and storage node 1400 or from the treated seed node 900 itself. The treated seed node 900 may also communicate or receive data from the software node 1100 through the data tagging, logging and storage node 1400. The treated seed inputs may include the coating ingredients 902, the coating integrity 904, the coating uniformity 906, the coating surface properties 908, or the coating moisture content 910. The treated seed node 900 may be associated with one or more databases of the seed treater system 10.

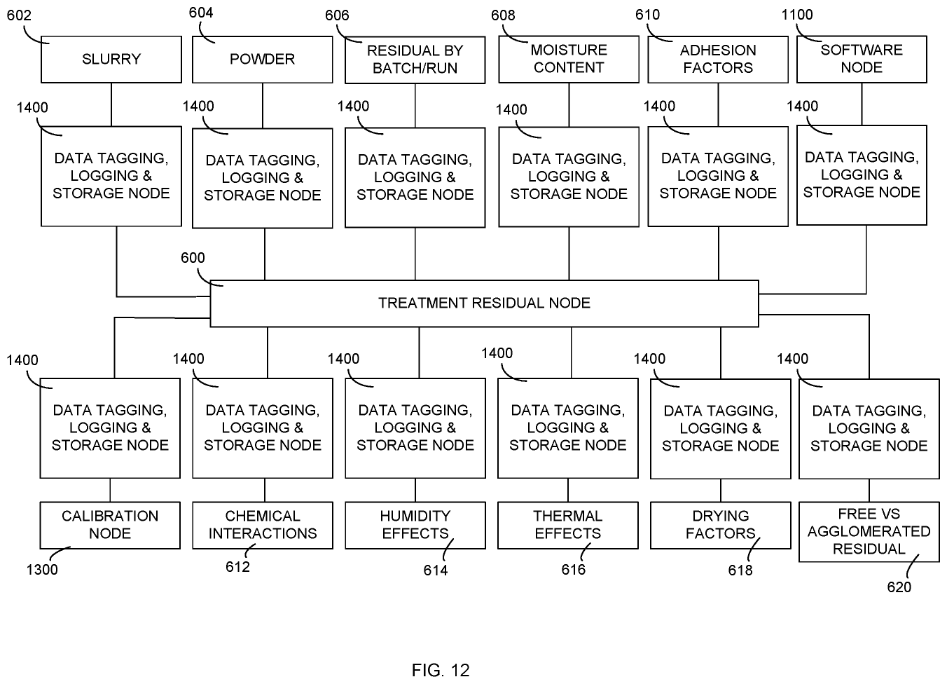

The treatment residual node 600 may communicate with other nodes of the seed treater system 10 and may collect, receive, or communicate different treated seed inputs to the other nodes as shown in FIG. 12. The treatment residual node 600 may be housed in the controller 100. The treatment residual node 600 can communicate data regarding different data points to the data tagging, logging and storage node 1400 or receive the required operating parameters from the data tagging, logging and storage node 1400. The treatment residual node 600 may also communicate data to and receive data from the calibration node 1300 to ensure that the treatment residual node 600 is functioning properly or optimally. The treatment residual node 600 may also communicate adjustments that need to be made to the operation parameters in light of data received from the other nodes, the data tagging, logging and storage node 1400 or from the treatment residual node 600 itself. The treatment residual node 600 inputs may be a slurry input 602 or powder input 604. Another input is the residual by batch/run 606, which may include how much residual matter is left in the tumbler after each run of the seed treater system 10. Another treatment residual node 600 input may be the moisture content 608, which may include the moisture content of the residual, the slurry, the powder, the seed or the treated seed. Adhesion factors 610 may be a treatment residual node 600 input, such as the likelihood that the slurry powder mix may adhere to the tumbler more than the seed or how much of the slurry powder mix adheres to the seed or to the tumbler. Another input may be chemical interactions 612 such as the chemical interactions between the seed and the slurry, the seed and the powder, the slurry and the powder, between the seed, slurry and powder, or between the tumbler and the seed, slurry, powder, or residue. Humidity effects 614 may be another treatment residual node input, such as how the humidity affects how much residue will adhere to the tumbler or be left in the tumbler and whether the amount of slurry or powder needs to be adjusted. Thermal effects 616 may be another input such as how the temperature affects the amount of residue left over. Another treatment residual node may be the drying factors 618, such as how fast will the residue material dry and stick to the tumbler after the seed treater system has finished a batch. Another input may be whether the residue is free or agglomerated residue 620. The treatment residual node may be associated with one or more databases of the seed treater system 10.

The different nodes and inputs allow the seed treater system 10 to adjust operating parameters to produce an optimally treated seed 1500 while reducing the cost and manpower needs to clean the machinery after a single batch or a few batches to remove residual buildup. In order to determine the optimal parameters, only one seed treater system 10 may need to be run to determine the operating parameters. Once the operating parameters are determined by one or a few seed treater systems 10, the determined operating parameters can be set for multiple seed treater systems 10, allowing a vast number of the seed treater systems 10 to run efficiently and reduce lag time between batches. In some aspects, the parameters may be adjusted after an inspection of the treated seed or the seed treater system 10.

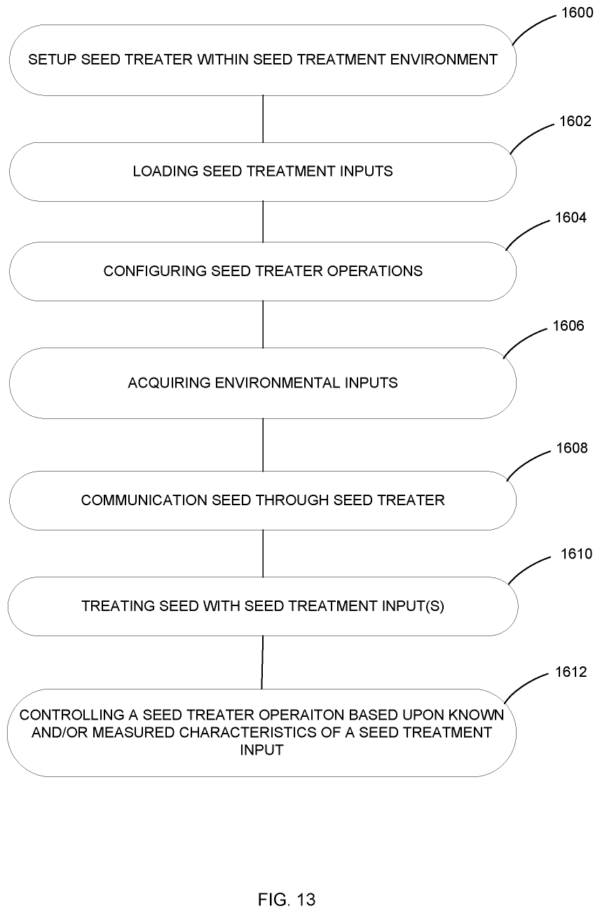

One method for seed treater data acquisition, commercialization, and use is disclosed and shown in FIG. 13. First a seed treater may be set up within the seed treater environment (1600). Seed treater software may be loaded on top the controller 100 of the seed treater. Next, seed treatment inputs may be loaded (1602). Next, seed treater operations can be configured (1604). The seed treater operations may be based on the seed treater inputs. Next, environmental inputs may be acquired (1606). The environmental inputs may include temperature, humidity, moisture content or water content in the air, barometric pressure, airflow, or thermal barrier properties. Next the seed may be communicated through the seed treater (1608). The seed can then be treated with the seed treatment input or inputs (1610). The treatment of the seed or operation of the seed treater at a controlled rate of treatment may be based on executables from the seed treater software and the data received from one or more seed treatment inputs, such as environmental inputs. The seed treater operation based upon known and/or measured characteristics of a seed treatment input (1612).

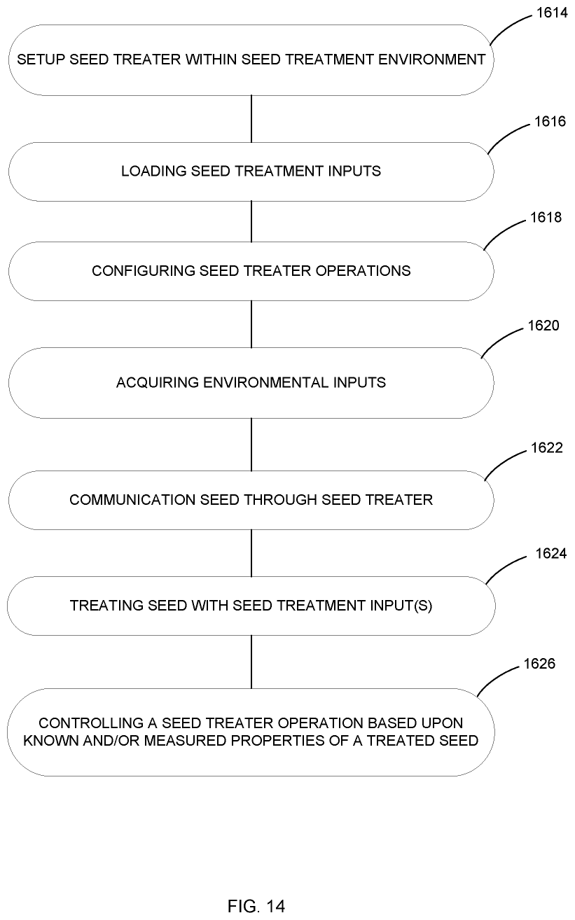

Another method for seed treater data acquisition, commercialization, and use is disclosed and shown in FIG. 14. The seed treater may be set up within the seed treater environment (1614). Next, the seed treatment inputs may be loaded (1616). The seed treater inputs may be loaded onto the seed treater itself or by using a remote device communicating with the seed treater through the seed treater system 10. Next, the seed treater operations can be configured (1618). Next, the environmental inputs may be acquired (1620). Next, the seed can be communicated through the seed treater (1622). Next the seed can be treated with the seed treatment input(s) (1624). Lastly, the seed treater operation may be controlled based upon known and/or measured properties of a treated seed (1626).

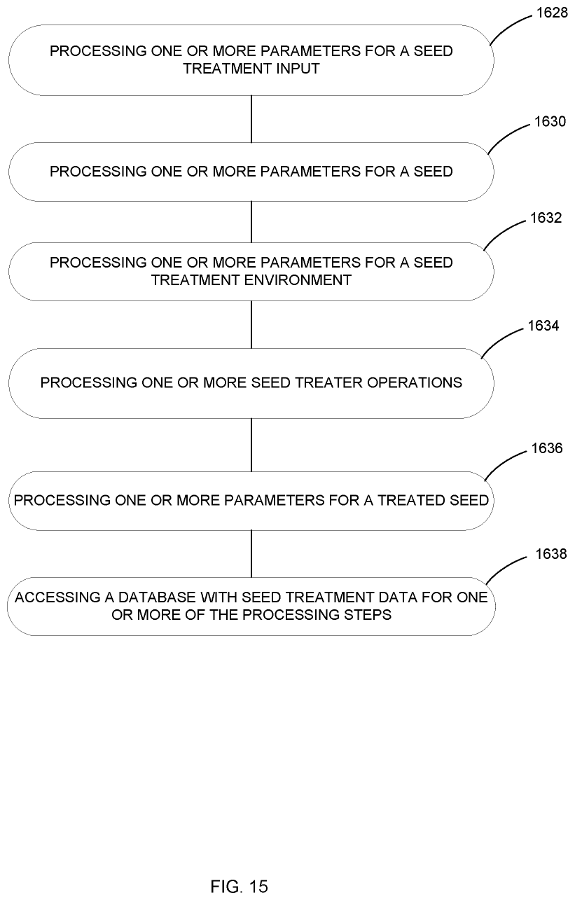

Another method for seed treater data acquisition, commercialization, and use is disclosed and shown in FIG. 15. First one or more parameters for a seed treatment input may be processed (1628). Next, one or more parameters for a seed may be processed (1630). The parameters may be various inputs from the seed node 500. Next, one or more parameters for the seed treatment environment can be processed (1632). The one or more parameters may be from the environment node. Next one or more seed treater operations can be processed (1634). This may include one or more inputs received from the seed treater operations node 700. Next one or more parameters of for a treated seed may be processed (1636). These may include inputs from the treated seed node 900. Lastly, a database with seed treatment data for one or more of the processing steps can be accessed (1638). The database may be accessed before the seed treater begins treating the seed, thereby selecting optimal or more efficient seed treatment operation parameters to increase the amount of treated seed and reduce residual buildup. The processing steps may occur as the data or inputs are being acquired by the seed treater system 10.

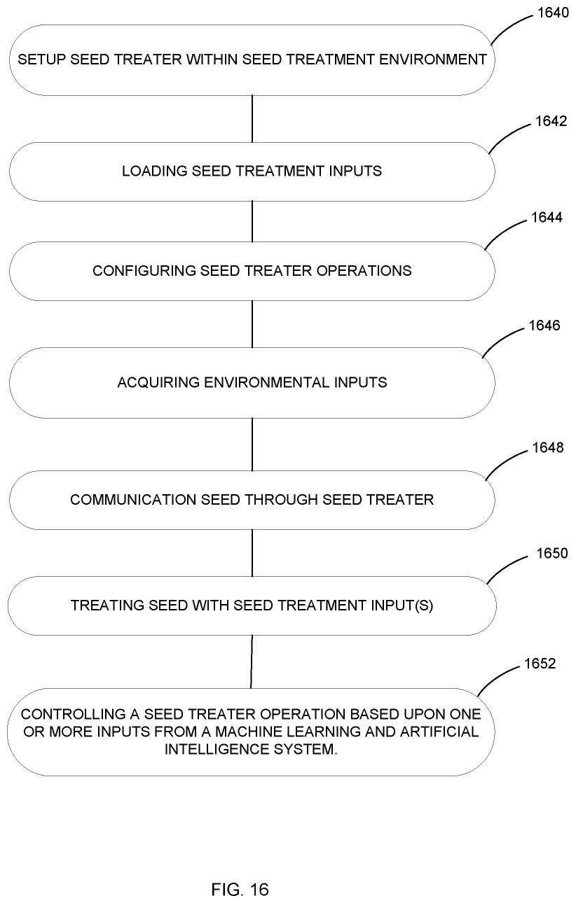

Another method for seed treater data acquisition, commercialization, and use is disclosed and shown in FIG. 16. First, the seed treater may be set up within the seed treatment environment (1640). Next, seed treatment inputs may be loaded into the seed treatment system (1642). Next, the seed treater operations can be configured (1644). Next, environmental inputs may be acquired (1646). Next, the seed can be communicated through the seed treater (1648). Next, the seed may be treated with the seed treatment input(s) (1650). Lastly, the seed treater operations may be based upon one or more inputs from a machine learning and artificial intelligence system or node 1000 (1652). For example, the seed treater may run batch of seeds through the seed treatment process and record the data, log the data, and analyze the data. The next time the same environmental inputs may be sensed, the machine learning and artificial intelligence system can determine what parameters should be kept the same and what parameters may need to be changed in light of the analyzed data.

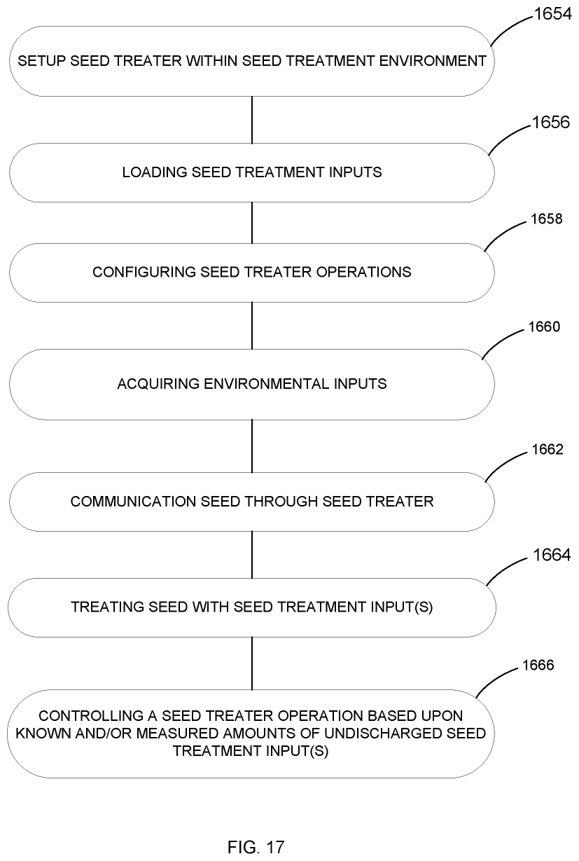

Another method for seed treater data acquisition, commercialization, and use is disclosed and shown in FIG. 17. First a seed treater may be set up within the seed treatment environment (1654). Next, the seed treatment inputs may be loaded into the seed treater system (1656). Next, the seed treater operations can be configured (1658). Next, environmental inputs can be acquired (1660). Next, seeds may be communicated through the seed treater (1662). Next, the seed may be treated with the seed treatment inputs (1664). Lastly, the seed treater operation may be controlled based upon known and/or measured amounts of undischarged treatment input(s) (1666). For example, the seed treater operation may be controlled based on how much residue was left in the batch by a previous run and adjusting the parameters to decrease the amount of residue left in the seed treater.

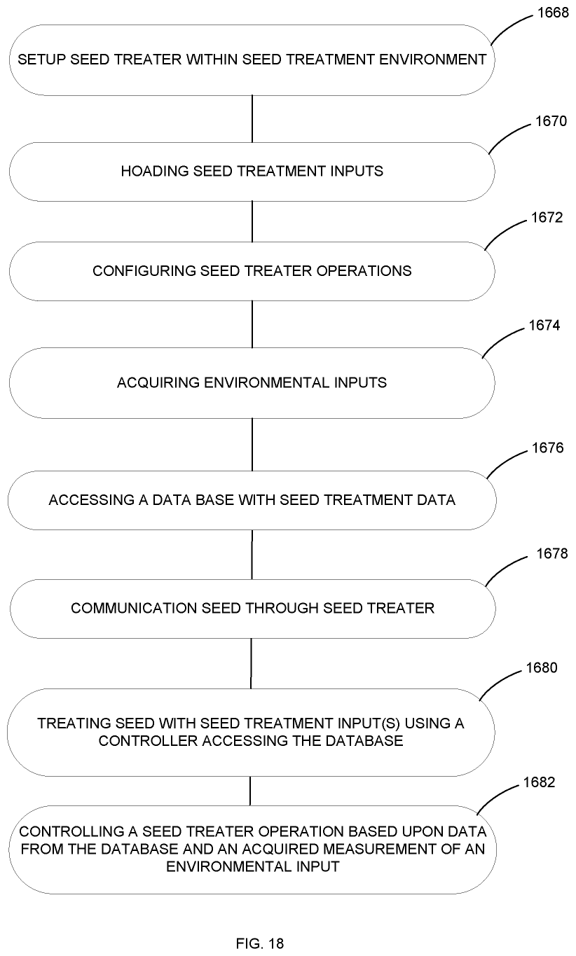

Another method for seed treater data acquisition, commercialization, and use is disclosed and shown in FIG. 18. First, the seed treater may be set up in the seed treater environment (1668). Next, the seed treatment inputs can be loaded (1670). Next, the seed treater operations may be configured (1672). Next, environmental inputs may be acquired (1674). Next, a database with seed treatment data can be accessed (1676). Next, a seed could be communicated through the seed treater (1678). Next, the seed may be treated with seed treatment input(s) using a controller 100 accessing the database. (1680). Lastly, the seed treater operation may be controlled based upon data from the databased and acquired measurement of an environmental input (1682). For example, if a temperature environmental input may be acquired, if the temperature reading is high and likely to cause seed sweating based on the data in the database, the amount of slurry can be adjusted based upon the likelihood of seed sweating.

Another method for seed treater data acquisition, commercialization, and use is disclosed and shown in FIG. 19. First, data may be monitored by one or more nodes 200, 300, 400, 500, 600, 700, 800, 900, 1000, 1100, 1200, 1300, or 1400 (1684). Next, the data can be tagged, logged and/or stored (1686). Next, the data may be collected for analysis (1688). Next, one or more machine learning and/or artificial intelligence models could be applied to the data (1690). Next, the data may be analyzed (1692). Next, the outcome(s) may be determined (1694). For example, the data can be analyzed to determine how the type of powder may interact with the slurry and determine the outcome as to whether the mixture is sufficient to treat the seed. Next, one or more nodes may be updated, adjusted, and/or validated (1696). The update, adjustment, or validation may be based on the analyzed data and determined outcome. Next, the data can be recorded (1698). Lastly, the process for converging actual seed treatment results with programmed seed treatment may be iterated (1700), thereby allowing a manufacturer or commercial producer to understand how each data point may affect the outcome of the treated seed and adjust the parameters accordingly without having to run multiple batches with the same parameters.

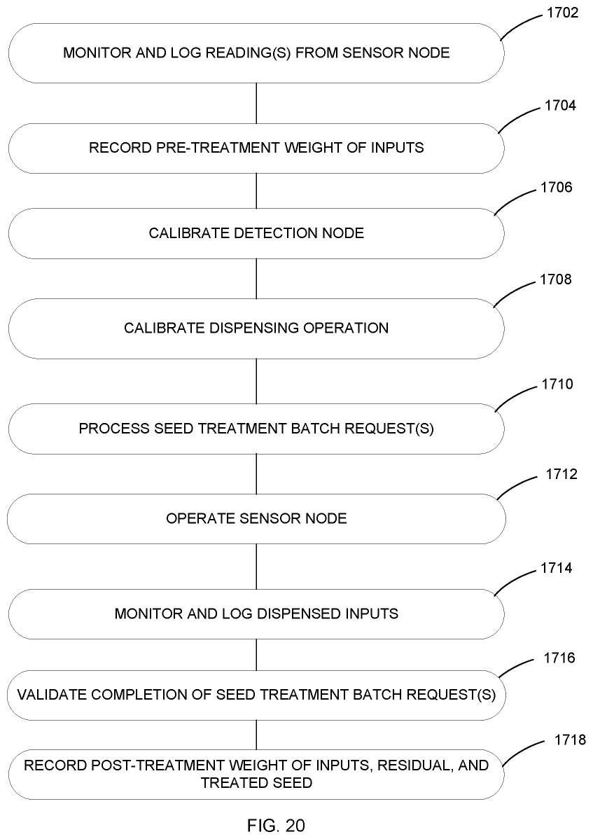

Another method for seed treater data acquisition, commercialization, and use is disclosed and shown in FIG. 20. First, readings from the sensor node 300 may be monitored and logged (1702). Next, pretreatment weights of inputs can be recorded (1704). This can include the weight of the slurry, the powder, the seed, or even the empty tumbler. Next, the detection node or sensor node 300 may be calibrated (1706). Next, the dispensing or communication of the liquid slurry, powder, and seed into the seed treater can be calibrated (1708). Next, the seed treatment batch request(s) may be processed (1710). Next, the sensor node 300 may be operated (1712). The sensor node 300 may record one or more environmental inputs or one or more machine inputs. Next, the dispensed inputs or treater operations inputs can be monitored and logged (1714). Next, the completion of the seed treatment batch request(s) may be validated (1716). Next, the post-treatment weight of inputs, residual, and treated seed may be recorded (1718). This can allow a user to determine how inputs sensed from the sensor node 300 affect the treated seed and residual left in the tumbler.

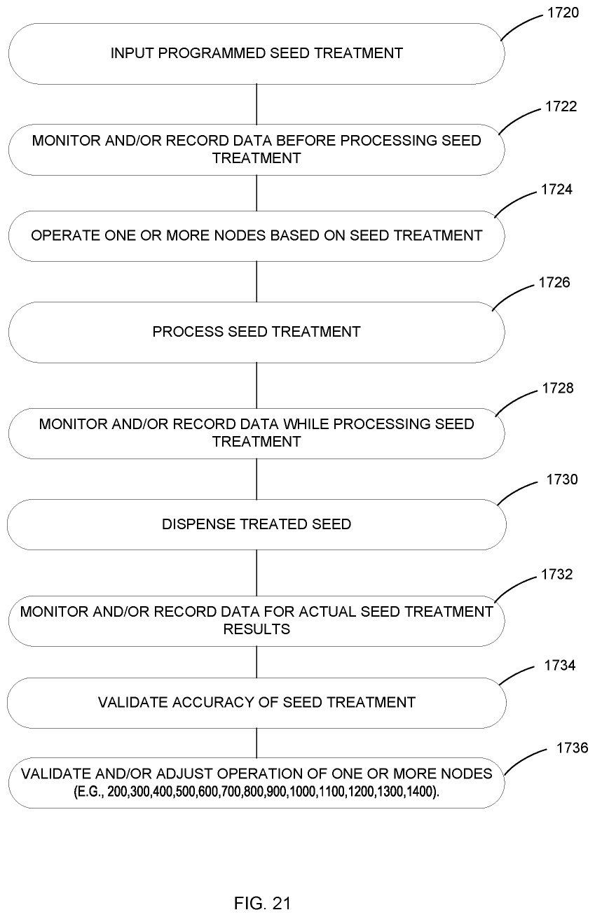

Another method for seed treater data acquisition, commercialization, and use is disclosed and shown in FIG. 21. First, the programmed seed treatment may be inputted (1720). Next, the data can be monitored and/or recorded before processing seed treatment (1722). Next, one or more nodes may be operated based on the seed treatment (1724). Next, the seed treatment may be processed (1726). Next, the data can be monitored and/or recorded while the seed treatment is processing (1728). Next, the treated seed may be dispensed (1730). Next, the data for the actual seed treatment results may be monitored and/or recorded (1732). Next, the accuracy of the seed treatment can be validated (1734). The accuracy may be validated based on data collected from one or more inputs of how the data changed through the seed treatment process. Next, the operation of one or more nodes 200, 300, 400, 500, 600, 700, 800, 900, 1000, 1100, 1200, 1300, or 1400 can be adjusted or validated (1736).

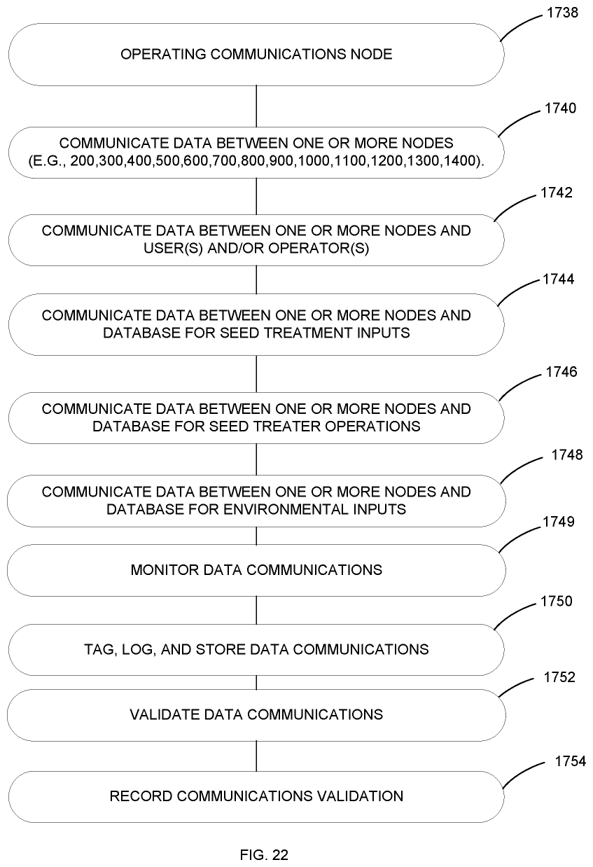

Another method for seed treater data acquisition, commercialization, and use is disclosed and shown in FIG. 22. First, the communications node 1200 may be operated (1738). Next, data may be communicated between one or more nodes 200, 300, 400, 500, 600, 700, 800, 900, 1000, 1100, 1200, 1300, or 1400 (1740). Next, the data could be communicated between one or more nodes and the user and/or operator(s) (1742). The data may be communicated to a remote device utilized by the user or operator. Next, the data can be communicated between one or more nodes and databased for seed treatment inputs (1744). Next, the data may be communicated between one or more nodes and a database for seed treater operations (1746). Next, the data may be communicated between one or more nodes and a database for environmental inputs (1748). Next, the data communications could be monitored (1749). Next, the data communications can be tagged, logged and stored (1750). Next, the data communications may be validated (1752). Lastly, the validation of the data communications can be recorded (1754).

Another method for seed treater data acquisition, commercialization, and use is disclosed and shown in FIG. 23. First, data may be monitored from one or more nodes 200, 300, 400, 500, 600, 700, 800, 900, 1000, 1100, 1200, 1300, or 1400 (1756). Next, data may be tagged from the one or more nodes (1758). Next, data can be logged from the one or more nodes (1760). Next, data could be stored from the one or more nodes (1762). Next, one or more machine learning and/or artificial intelligence models may be applied to the data from the one or more nodes (1764). This can include how the operation parameters may need to be changed based on the input data. Next, a batch report(s) may be created for the data (1766). Next, the data can be validated (1768). Next, treater operations may be adjusted or changed (1770). Lastly, the outcomes may be determined or validated (1772). This can be based on whether the changed or adjusted parameters produced the data as predicted.

Another method for seed treater data acquisition, commercialization, and use is disclosed and shown in FIG. 24. First seed treatment batch requests may be received (1774). Next, the operation of one or more nodes can be confirmed (1776). Next, the pre-batch operation(s) may be initiated (1778). Next, the batch operations may be calibrated (1780). The batch operations may be calibrated based on data received during pre-batch operations. Next, the seed treatment batch operation(s) can be initiated (1782). Next, the batch operation(s) may be monitored (1784). Next, the batch operations could be adjusted if needed based on the monitoring (1786). Next, the seed treatment batch request(s) may be dispensed (1788). Lastly, the batch requests may be validated (1790). The validation may occur by comparing actual data to predicted data.

Another method includes such steps, as, for example, providing a seed treater with one or more seed treatment inputs, one or more seed treater operations, and one or more environmental inputs for treating seed at a controlled rate, treating seed with at least one of the one or more seed treatment inputs, and controlling at least one of the one or more seed treater operations based on the at least one of the one or more seed treatment inputs. The method may also include, for example, such step as controlling at least one of the one or more seed treater operations based on inspection of one or more properties of a treated seed. Such analysis may be alone or performed in combination with one or more points of human inspection, such as by visual inspection and/or conducting one or more tests. The method may also include, for example, such step as accessing a database of seed treatment data as part of the controlling step. The method may also include, for example, such step as controlling at least one of the one or more seed treater operations based on at least one of the one or more environmental inputs. The method may also include, for example, such step as adjusting at least one of the one or more seed treater operations based on at least one of the one or more seed treatment inputs and the controlled rate. The method may also include, for example, such step as analyzing at least one of the one or more seed treatment inputs, the one or more seed treater operations, the one or more environmental inputs for treating seed at the controlled rate using a machine learning or artificial intelligence system for converging actual seed treatment results with programmed seed treatment parameters. Such analysis may be alone or performed in combination with one or more points of human inspection, such as by visual inspection and/or conducting one or more tests. The method may also include, for example, such step as controlling the at least one of the one or more seed treater operations based on at least one of the one or more seed treatment inputs undischarged by the seed treater.

An additional method for scaling seed treater data acquisition, commercialization, and use is disclosed. The method includes such steps as, for example, providing a seed treater with one or more seed treatment inputs, one or more seed treater operations, one or more environmental inputs, and a controller 100 for treating seed at a controlled rate, acquiring data from a data store for at least the one or more seed treatment inputs, measuring at least one of the one or more environmental inputs, and controlling at least one of the one or more seed treater operations based at least in part on data retrieved from the data store and measurements from the at least one of the one or more environmental inputs. The method may also include, for example, such step as acquiring one or more measurements from at least one or more properties of a treated seed for controlling the at least one of the one or more seed treater operations. The method may also include, for example, such step as acquiring one or more measurements of undischarged portions of at least one of the one or more seed treatment inputs for controlling the at least one of the one or more seed treater operations. The method may also include, for example, such step as controlling at least one of the one or more seed treater operations based on at least one of the one or more seed treatment inputs, the at least one of the one or more environmental inputs, and the controlled rate. The method may also include, for example, such step as controlling at least one of the one or more seed treater operations based at least in part on data retrieved from the database for the seed and one or more measurements of the seed. The method may also include, for example, such step as analyzing at least one of the one or more seed treatment inputs, the at least one of the one or more seed treater operations, the at least one of the one or more environmental inputs using a machine learning and artificial intelligence system for converging actual seed treatment results with programmed seed treatment parameters. The method may also include, for example, such step as loading seed treater software onto the controller 100, loading seed treatment data for the at least one or more seed treatment inputs, and operating the seed treater at the controlled rate using executables from the seed treatments software and the seed treatment data for the at least one or more seed treatment inputs.

In another aspect of the present disclosure, a modulated seed treater system for existing continuous flow and rotary seed treaters is disclosed. Existing seed treaters lack the features and advantages of the present disclosure. In view of the foregoing, modules containing the hardware and software solutions of the present disclosure could be applied to an existing seed treater to provide operating the seed treater thereby converging the actual seed treatment results of the seed treater with the programmed seed treatment parameters of the present disclosure. In at least one aspect, the modulated seed treater includes all the elements and disclosure of the present disclosure but applied to an existing seed treater. For example, an existing seed treater may be configured with, but not limited to, a sensor array for capturing data for a sensor node 300, a graphical user interface for receiving users' input to the treater operations node 700, a programmable logic controller 100, and seed treatment software of software node 1100 for operating the treater.

The disclosure is not to be limited to the particular aspects described herein. In particular, the disclosure contemplates numerous variations in a continuous flow seed treater. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of aspects, processes, or methods of the disclosure. It is understood that any other modifications, substitutions, and/or additions can be made, which are within the intended spirit and scope of the disclosure.

What is claimed is:

1. A method for seed treater data acquisition, commercialization, and use, comprising:
providing a seed treater with one or more seed treatment inputs having one or more known properties, one or more seed treater operations, and one or more environmental inputs having one or more measurable properties resulting from an environment of the seed treater for treating seed;
treating seed in the seed treater with at least one of the one or more seed treatment inputs; and
controlling at least one of the one or more seed treater operations based on one or more programmed seed treatment parameters, the one or more known properties of the at least one of the one or more seed treatment inputs and the one or more measurable properties of the at least one of the one or more environmental inputs.

2. The method of claim 1, further comprising:
adjusting the at least one of the one or more seed treater operations based on inspection of one or more properties of a treated seed.

3. The method of claim 1, further comprising:
storing the one or more known properties for the seed treatment inputs and the one or more measurable properties for the environmental inputs in a seed treater database;
accessing the seed treater database; and
controlling the at least one of the one or more seed treater operations based on the one or more known properties of the at least one of the one or more seed treatment inputs and the one or more measurable properties of the at least one of the one or more environmental inputs.

4. The method of claim 1, further comprising:
acquiring the one or more measurable properties of the at least one of the one or more environmental inputs with one or more sensors within the environment of the seed treater.

5. The method of claim 1, further comprising:
adjusting a rate of operation of the at least one of the one or more seed treater operations based on the one or more known properties of the at least one of the one or more seed treatment inputs and the one or more measurable properties of the at least one of the one or more environmental inputs.

6. The method of claim 1, further comprising:
converging actual seed treatment results of the seed treater with the programmed seed treatment parameters using machine learning or artificial intelligence.

7. The method of claim 1, further comprising:
adjusting a rate of operation of the at least one of the one or more seed treater operations based on one or more sensor readings taken during operation of the seed treater.

8. A system for seed treater data acquisition, commercialization, and use, comprising:
a seed treater with one or more seed treatment inputs having one or more known properties, one or more seed treater operations, and one or more environmental inputs having one or more measurable properties resulting from an environment of the seed treater;
a seed treater database for storing the one or more known properties of the seed treatment inputs;
one or more measurements for acquiring the one or more measurable properties resulting from the one or more environmental inputs from the environment of the seed treater;
a controller operating the at least one of the one or more seed treater operations based at least in part on programmed seed treatment parameters, accessing the one or more known properties of the seed treatment inputs from the seed treatment database and the one or more measurements taken from one or more measurable properties resulting from the one or more environmental inputs from the environment of the seed treater.

9. The system of claim 8, further comprising:
one or more measurements from one or more sensors for acquiring one or more properties of a treated seed for adjusting one or more seed treater operations.

10. The system of claim 8, further comprising:
a rate of operation of the at least one of the one or more seed treater operations adjusted by the controller based on the one or more known properties of the at least one of the one or more seed treatment inputs and the one or more measurements taken from one or more measurable properties resulting from the one or more environmental inputs from the environment of the seed treater.

11. The system of claim 8, further comprising:
a rate of operation of the at least one of the one or more seed treater operations adjusted by the controller based on one or more sensor readings taken during operation of the seed treater.

12. The system of claim 8, further comprising:
a rate of operation of the at least one of the one or more seed treater operations adjusted by the controller based on feedback from a machine learning and artificial intelligence system.

13. The system of claim 8, further comprising:
a machine learning and artificial intelligence system operable by the controller for converging actual seed treatment results of the seed treater with the programmed seed treatment parameters using machine learning or artificial intelligence.

14. A method for seed treater data acquisition, commercialization, and use, comprising:
providing a seed treater with one or more seed treatment inputs having one or more known properties, one or more seed treater operations, one or more environmental inputs from an environment of the seed treater, and a controller for treating seed at a controlled rate;
measuring at least one of the one or more environmental inputs from the environment of the seed treater;
controlling at least one of the one or more seed treater operations based at least in part on the one or more known properties for the one or more seed treatment inputs and measurements from the at least one of the one or more environmental inputs from the environment of the seed treater.

15. The method of claim 14, further comprising:
acquiring one or more measurements from at least one or more properties of a treated seed for controlling the at least one of the one or more seed treater operations.

16. The method of claim 14, further comprising:
acquiring one or more measurements of undischarged portions of at least one of the one or more seed treatment inputs for controlling the at least one of the one or more seed treater operations.

17. The method of claim 14, further comprising:
controlling at least one of the one or more seed treater operations based on at least one of the one or more seed treatment inputs, the at least one of the one or more environmental inputs, and the controlled rate.

18. The method of claim 14, further comprising:
controlling at least one of the one or more seed treater operations based at least in part on data retrieved from the database for the seed and one or more measurements of the seed.

19. The method of claim 14, further comprising:
analyzing at least one of the one or more seed treatment inputs, the at least one of the one or more seed treater operations, the at least one of the one or more environmental inputs using a machine learning and artificial intelligence system for converging actual seed treatment results with programmed seed treatment parameters.

20. The method of claim 14, further comprising:
loading seed treater software onto the controller;
loading seed treatment data for the at least one or more seed treatment inputs;
operating the seed treater at the controlled rate using executables from the seed treatments software and the seed treatment data for the at least one or more seed treatment inputs.
